(19) United States
(12) Patent Application Publication
(10) Pub. No.: US 2009/0304868 A1
(43) Pub. Date: Dec. 10, 2009

(54) Controlled release cooling additive composition

(75) Inventors: Magesh Sundaram, Chicago, IL (US); David Alan Little, Newtown, PA (US)

Correspondence Address: STOUT, UXA, BUYAN & MULLINS LLP, 4 VENTURE, SUITE 300, IRVINE, CA, 92618, US

(73) Assignee: Dober Chemical Corporation, Woodridge, IL (US)

(21) Appl. No.: 12/455,041

(22) Filed: May 26, 2009

Related U.S. Application Data
(63) Continuation-in-part of application No. 12/154,898, filed on May 27, 2008.
(60) Provisional application No. 61/130,072, filed on May 27, 2008.
(60) Provisional application No. 61/163,796, filed on Mar. 26, 2009.

(51) Int. Cl. A23L 2/74; A23L 2/44

(52) U.S. Cl. 426/66; 210/143

(57) ABSTRACT

Controlled release potability additive compositions for use in potable water systems include a core containing at least one potability additive component and a polymeric coating. Controlled release systems for releasing potability additive components into potable water systems are also provided. Methods of using such compositions and systems to benefit potability of water in potable water systems, for example, drinking water systems, are disclosed.

### CROSS-REFERENCE TO RELATED APPLICATIONS

The present application is a continuation-in-part of application Ser. No. 12/154,898, filed May 27, 2008 and the present application claims the benefit of U.S. Provisional Application Ser. Nos. 61/130,072 filed May 27, 2008 and 61/163,796, filed Mar. 26, 2009, the disclosures of each of these applications being incorporated in their entirety herein by reference.

### BACKGROUND OF THE INVENTION

Traditionally, additives such as anti-foulants, anti-scaling agents, corrosion inhibitors, buffering and pH agents, microbiocides and the like are added directly to the liquid solutions, e.g., water, of aqueous systems, for example, closed and open coolant systems, boiler feed water systems and other industrial aqueous systems as needed to prevent scale deposition, corrosion of metal surfaces and similar fouling of the systems, as well to maintain proper pH levels.

Various methods of introducing additives to industrial aqueous systems have been developed. For instance, a solid additive material may be added directly to the industrial system which dissolves in the system. However, this method cannot maintain a steady concentration level of additive within the system. Initially, there would be a high level of the additives released into the system, and within a short time the additives are depleted. Additionally, a significant draw back of this method is the danger of overdosing the system with particular additives which are initially released.

Various methods of introducing additives to fluid systems, generally, have been proposed. Rhode U.S. Pat. No. 3,749,247 describes a container for releasing an oxidation inhibitor into hydrocarbon-based lubricating oil in a working engine. The oxidation inhibitor is held in a polyolefin container that permits the additive to permeate through the container wall into the oil. A further approach is described by Lefebvre U.S. Pat. No. 5,591,330, which discloses a hydrocarbon oil filter wherein oxidation additives in a thermoplastic material are mounted in a casing between a particle filtering material and a felt pad. Reportedly, the thermoplastic material dissolves in the presence of high temperature oil thereby releasing the additives. Additionally, an additive release device for use in an engine hydrocarbon fuel line is proposed by Thunker et al U.S. Pat. No. 5,456,217. The latter device comprises a partially permeable cartridge positioned in the filling neck of the fuel tank so that whenever fuel is added a portion of the additive contents of the cartridge is released into the tank.

Aqueous-based coolants present an environment distinct from those of hydrocarbon fluids. For instance, most thermoplastics do not dissolve in aqueous solutions. Moreover, relatively large quantities of additives need to be provided in a typical aqueous coolant. Sudden provision of such large amounts of additives can cause a “slug” of material to precipitate and circulate in the system, which can result in damage and failure of pump seals.

Attempts have been made in the prior art to treat industrial water systems by using controlled release coatings. For example, Characklis in U.S. Pat. No. 4,561,981 (issued Dec. 31, 1985) disclosed a method for controlling, preventing or removing fouling deposits, particularly in pipelines, storage tanks and the like by microencapsulating fouling control chemicals in a slow release coating. The coating material is described as being any material compatible with the fouling control chemical which is capable of sticking to the fouling deposit site. However, the coating materials as disclosed by Characklis may dissolve in a cooling system and create further corrosion problems.

Recently, Mitchell et al. in U.S. Pat. No. 6,010,639 disclosed that a terpolymer may be used as a coating for cooling additives for use in closed cooling systems, such as engine cooling systems. Also, Blakemore et al. in U.S. Pat. No. 6,878,309 disclosed that copolymers derived from two different ethylenically unsaturated monomers may be used as coatings for additives in cooling towers and other coolant systems.

There are a number of important distinctions between industrial aqueous systems and potable water systems. For example, industrial aqueous systems provide or treat aqueous liquids useful and effective in industrial applications. Industrial aqueous systems often require a relatively large number of different additives whereas treatment of potable/drinking water systems tends to employ more precise addition of fewer different additives, for example, relative to industrial aqueous systems. In many instances, potable water systems may only be treated with one or more compounds or compositions approved, for example, by one or more federal, state and/or local government agencies for use in such applications. Industrial aqueous liquids are not potable, that is, for example and without limitation, are not intended for and are not suitable for bathing or direct consumption by humans, or for use in irrigating fruits and vegetables, or processing foods, to be consumed by humans.

Although additives are employed in industrial aqueous systems, under or over dosing of additives in such industrial systems may result in reduced equipment efficiency and useful life. However, such under or over dosing of additives in industrial systems does not have an immediate or direct effect on human life.

This is not the case with potable water systems, for example, drinking water systems. The water from potable water systems does have a direct impact on the bodies of humans. Thus, an over or under dosage of additives in such potable water may have an immediate and direct detrimental effect on the health, or even the life, of humans. Therefore, it is critical that the proper and safe amounts of additives, for example, government approved additives, are added to potable water, for example, drinking water.

To this end, municipalities and other governmental entities employ elaborate and expensive metering and monitoring equipment to ensure that desired amounts of additives are included in potable/drinking water. This equipment, although usually effective, can fail, resulting in situations in which the potable water, e.g., drinking water, is not safe for use. This results in a substantial problem for the people who rely on the potable water, for example, for drinking, cooking and other uses.

There continues to be a need for providing additives to potable water systems, for example, drinking water systems. In particular, a need still exists for controlled additive release compositions and additive release systems in potable water systems.

### SUMMARY OF THE INVENTION

New compositions, systems and methods for providing additives to potable water systems, for example, drinking water systems, have been discovered. The present compositions, systems and methods provide a high degree of performance effectiveness and efficiency in treating water in potable water systems, such as drinking water systems, with such performance benefits being obtained cost effectively, for example, without the need for expensive metering equipment and the like. The present compositions, systems and methods provide the desired dosing of additives on a consistent and/or constant basis, for example, on a 24 hours a day, 7 days a week basis, without metering equipment. Thus, the risks of overdosing and underdosing of water in potable/drinking water systems is substantially reduced relative to dosing using mechanical metering systems, which are prone to mechanical break down and/or require periodic maintenance. Moreover, the present compositions, systems and methods are straightforward, relatively inexpensive, and are easy to install, maintain, use and practice.

In one broad aspect, the present invention provides potability additive compositions, for example, for use in potable water systems. The present compositions provide for controlled, for example and without limitation, delayed and/or sustained and/or more effectively timed, sequenced and/or complete, release of additive components. Such release helps maintain a substantially consistent or even substantially constant level of potability additive components in potable water systems over an extended period of time, for example, without the need for extensive and expensive system metering and/or monitoring.

The present potability additive compositions often comprises one or more potability additive components which are effective, when released into water in a potable water system, in enhancing the potability of the water. As used herein, the term “enhancing the potability of the water” refers to benefiting the water to at least one (1) make the water potable or more potable, (2) maintain the potability of the water, (3) increase the potability of the water, (4) make it easier to produce and/or deliver potable water from the potable water system and the like and combinations of two or more thereof. Any additive component which, when released into water in a potable water system, is effective in enhancing the potability of the water and/or which has a beneficial effect on the potability of the water, is considered to be a potability additive component within the scope of the present invention.

In a useful embodiment, the present invention provides potability additive compositions for drinking water systems, controlled release systems for releasing potability additive compositions into drinking water systems and methods of using such compositions and systems in drinking water systems, for example, to treat water in drinking water systems.

In one embodiment, a potability additive composition is provided which comprises a water-soluble potability additive component and a controlled release component substantially surrounding the additive component. The controlled release component is effective, when the composition is placed in a potable water system, in controlling release of the potability additive component into water in the potable water system.

The potability additive component of the present potability additive composition has at least one active ingredient selected from the group consisting of microbiocides, microbiocide precursors, buffering components, flavor enhancing components, corrosion inhibitor components, dispersant agents, surfactants and the like and mixtures thereof. For example, water, such as potable water or drinking water, often may be pH adjusted or buffered, or be treated with one or more additives to prevent corrosion and/or to improve taste. To illustrate, it is common practice to add polyphosphate to control lead leaching from pipes transporting the water. This practice often occurs in older sections of urban water systems. In a very useful embodiment, the potability additive component comprises one or both of a microbiocide component and a microbiocide component precursor.

In one broad aspect of the present invention, the controlled release component of the potability additive composition for use in potable water systems substantially surrounds or encapsulates the potability additive component effective in treating potable water systems, for example, drinking water systems. The controlled release component may comprise a coating substantially surrounding the potability additive component. The controlled release component may comprise a defined polymeric component, for example, and be effective in controlling, for example and without limitation, slowing or reducing, the rate of release of the potability additive component into potable water systems, for example, drinking water systems. Such controlled and/or reduced release rate is relative to the release rate of the potability additive component in the potable water system from a substantially identical composition without the controlled release component, e.g., without the controlled release component coating.

In one embodiment, the controlled release component comprises a copolymer made up of units from two or more monomers. For example, the copolymer may include units from one or more of vinylacetate, vinyl versatate, and other vinyl neoalkanoates and the like and mixtures thereof.

In another broad aspect of the present invention, controlled release systems for releasing a potability additive component in a potable water system are provided and designed to provide gradual and/or sustained and/or substantially controlled, release of the potability additive component into the water of potable water systems, for example, drinking water systems. Such systems comprise a casing, for example, which is impermeable to the water in the potable water system that is to be treated using the system. The casing defines a substantially hollow interior and at least one opening, for example and without limitation, located in an outermost wall of the casing, into the hollow interior. In one embodiment, the casing includes only one opening. A potability additive component is provided or is located in the hollow interior of the casing. At least one element is provided or positioned in proximity to the at least one opening of the casing and is effective in controlling the release of the potability additive component into water in the potable water system in contact with the casing.

Because the potability additive component is released only through a limited portion of the casing, for example, over a relatively prolonged period of time, and in addition because the size of the at least one opening and/or the type/material of construction of the element can be independently selected to provide the desired release rate, it has been found that the present systems are very effective and convenient in controlling the release rate of the potability additive component into a potable water system over an extended period of time. Such flexibility and consistency of additive release control is particularly valuable in treating water in potable water systems to protect and ensure the health and well being of the humans using the water from such potable, e.g., drinking, water systems.

In another broad aspect, the invention is directed to methods for releasing the potability additive component, for example, at a sustained and/or otherwise controlled rate, into the water in a potable water system, for example, a drinking water system.

In one embodiment, the present methods comprise placing a potability additive composition as set forth elsewhere herein in or in contact with a potable water system. When the potability additive composition, for example, a coated potability additive component, comes in contact with water in a potable water system, release of the potability additive component into the potable water system is obtained, for example and without limitation, by slow dissolution of the potability additive component in water through the polymeric coating.

In one embodiment, the present methods comprise placing a controlled release system as set forth elsewhere herein in or in contact with a potable water system. When the casing of the controlled release system is exposed to a potable water system, the water passes through, for example, diffuses through, and/or at least wets the element and contacts and/or comes in contact with the potability additive component in the casing. Release of the potability additive component into the potable water system is thus obtained, for example and without limitation, by diffusion of the potability additive component through the water permeable element.

Any feature or combination of features described herein are included within the scope of the present invention provided that the features included in any such combination are not mutually inconsistent as will be apparent from the context, this specification, and the knowledge of one of ordinary skill in the art. In addition, any feature or combination of features may be specifically excluded from any embodiment of the present invention.

Additional aspects and advantages of the present invention are set forth in the following detailed description, examples and claims, particularly when considered in conjunction with the accompanying drawings in which like parts bear like reference numerals.

### BRIEF DESCRIPTION OF THE DRAWINGS

FIG. 1 is a cross-sectional view of a cylindrical shaped controlled release system for a potability additive component in accordance with the present invention.

FIG. 2 is a schematic illustration showing the system of FIG. 1 in use in conjunction with a potable water system line.

FIG. 3 is a cross-sectional view of an additional embodiment of a controlled release system for a potability additive component in accordance with the present invention.

FIG. 4 is a cross-sectional view of another embodiment of a controlled release system for a potability additive component in accordance with the present invention.

FIG. 5 is a view taken generally along the line of 5-5 of FIG. 4.

FIG. 6 is a somewhat schematic view of a further embodiment of a controlled release system for a potability additive component in accordance with the present invention.

FIG. 7 is a somewhat schematic view of a valved embodiment of a controlled release system for a potability additive component in accordance with the present invention.

FIG. 8 is a somewhat schematic view of a further valved embodiment of a controlled release system for a potability additive component in accordance with the present invention.

FIG. 9 is a somewhat schematic view of an additional valved embodiment of a controlled release system for a potability additive component in accordance with the present invention.

FIG. 10 is a perspective view of a cap or lid and casing body for use with the cap of a still further additive composition container of the present invention.

FIG. 11A is a bottom plan view of the casing body shown in FIG. 10.

FIG. 11B is a bottom plan view of the casing body shown in FIG. 10 with a valve, such as an umbrella valve, installed.

FIG. 12 is a top plan view of an alternate embodiment of a cap or lid of an additive composition container of the present invention.

FIG. 13 is a view of the inner portion of the cap or lid shown in FIG. 12.

FIG. 14 is a side plan view of yet another additive composition container of the present invention with the cap or lid removably secured to the casing body.

FIG. 15 is an exploded perspective view of certain components of a further alternate additive composition container of the present invention.

FIG. 16 is a schematic view of a still further alternate additive composition container of the present invention.

### DETAILED DESCRIPTION OF THE INVENTION

The present invention relates to potability additive compositions, controlled release systems for potability additive components and methods for use thereof in potable water systems, including, without limitation, drinking water systems.

In one embodiment, the present potability additive compositions comprise a potability additive component, for example, a water soluble potability additive component and a controlled release component, for example, substantially surrounding the potability additive component. The controlled release component is effective, when the composition is placed in a potable water system, in controlling release of the potability additive component into water in the potable water system.

In one embodiment, a method is provided for providing or maintaining an effective concentration of at least one potability additive component in a potable water system. The method comprises placing a controlled release additive composition, such as described elsewhere herein, in contact with a potable water system, for example, in contact with water in a potable water system.

Unless otherwise expressly noted to the contrary, each of the words “include”, “includes”, “included” and “including,” and the phrase “for example” and abbreviation “e.g.” as used herein in referring to one or more things or actions means that the reference is not limited to the one or more things or actions specifically referred to.

As used herein, a potable water system may include, without limitation, a system employed to treat and/or deliver to an application site water to achieve and/or maintain the potability of such water. As used herein, a potable water system includes, without limitation, the water being treated and/or the potable water being delivered to an application site, as well as the mechanical components, such as pumps, pipes, valves, holding ponds, tanks and the like used to treat and/or deliver and/or store the water.

Potable water systems may be susceptible to unwanted growth of one or more types and/or species of microorganisms. For example, and without limitation, included among such microorganisms are bacteria, fungi, viruses, spores, and the like and combinations thereof. Such microorganisms or microbes may be present in the environment in which the potable water system is located and/or is employed. In addition, or alternatively, the potable water system may be such that the potability additive component substantially surrounded by the controlled release component of the potability additive composition is effective to substantially prevent any significant growth of one or more particular microorganisms, for example and without limitation, one or more microorganisms that may be introduced into the potable water system unintentionally or otherwise through human or natural intervention.

In other words, the potability additive component in the present invention may be employed to substantially prevent any microbial growth in the potable water system, to control the growth of one or more microorganisms in the potable water system and/or to reduce the population of one or more microorganisms in the potable water system, for example, a potable water system which is contaminated with an excessive population or amount of one or more microorganisms. Thus, the present potability additive composition present can be used to substantially prevent microbial growth, to control microbial growth and/or to reduce microbial growth in a potable water system.

The potability additive component for use in the present invention is such as to be effective to serve some beneficial function within the potable water system, for example, to enhance the potability of the water in the potable water system.

In one embodiment, the potability additive components of the present potability additive compositions comprise at least one active ingredient selected from microbiocides, microbiocide precursors, buffering components, corrosion inhibitors, dispersant agents, surfactants and the like and mixtures thereof. These additives may include, but are not limited to, such additive or additives which is (are) conventionally used in potable water systems, for example, as noted elsewhere herein.

In a very useful embodiment, the potability additive component comprises one or both of a microbiocide component and a microbiocide precursor component, for example, may comprise an additive component selected from microbiocides, microbiocide components and mixtures thereof. In one embodiment, a microbiocide component and/or microbiocide precursor component may be the only potability additive component present.

Any suitable, for example and without limitation, effective, microbiocide may be employed in accordance with the present invention. The microbiocide is effective, for example, when employed in an effective and safe concentration range, such as that in conformity with government regulation/approval, in controlling the microbe or microbes, for example, the specific microbe or microbes, present in the potable water system to be treated. Such microbes may include, without limitation, bacteria, viruses, fungi, spores and the like, many of which, if left to reproduce or grow without control, are known to contaminate, foul or otherwise adversely affect or even substantially destroy the potability of water in the potable water system.

Suitable microbiocides include, without limitation, water soluble materials which have no significant detrimental effect on the potability of the water in the potable water system being treated or on the performance of the potability additive compositions. In one useful embodiment, the microbiocide is an U.S. Environmental Protection Agency (EPA) registered microbiocide component or is included in an U.S. EPA registered microbiocide composition. In a useful embodiment, the potability additive component is an U.S. FDA approved potability additive component, such as an approved microbiocide component, which is approved for use in a specific use, for example, in which the water is consumed by humans or comes in contact with something that is consumed by humans, such as in food and food contacting applications. A biocide or microbiocide component may be an EPA registered material and, in addition, approved for a specific use by the FDA.

Examples of useful microbiocide components include, without limitation, halogen-containing microbiocides, such as microbiocides which include combined halogen, for example, chlorine-containing microbiocides, bromine-containing microbiocides and the like and mixtures thereof; halogen-releasing microbiocides, such as materials, for example, materials which include releasable halogen, which release microbicidally effective amounts of halogens, e.g., chloride, bromine and the like, into potable water systems and the like and mixtures thereof; thiocarbamate microbiocides and the like and mixtures thereof; thiazoline microbiocides and the like and mixtures thereof; thiocyano microbiocides and the like and mixtures thereof; sulfate microbiocides and the like and mixtures thereof; quaternary ammonium microbiocides and the like and mixtures thereof; metal-containing microbiocides and the like and mixtures thereof; and the like and mixtures thereof. The microbiocides useful in the present invention may be metal-free microbiocides.

The choice of microbiocide component may be dependent, even highly dependent, on the specific application involved, for example, on the specific potable water system to be treated. For example, if a drinking water system is to be treated, relatively few microbiocides may be suitable, for example, microbiocides registered by the EPA and approved for this specific use by the FDA. However, if the potable water system to be treated involves water used to make, clean or cool materials subsequently used to contact or contain food, for example, and without limitation, indirect contact such as cleaning knives in a meat packing plant, making drinking water bottles, making the glue to close cereal boxes, etc., or in swimming pools, cooling spray devices or other direct human contact applications, then the list of suitable microbiocides grows considerably. For example, metal-containing biocides are often not used in drinking water but they might be acceptable to cool the molds that are used to blow plastic foam cups.

Materials, for example and without limitation, such as those identified herein, may be used as biostats which are effective, when employed in an effective and safe concentration range, as noted elsewhere herein, in inhibiting the growth of microbes, for example, rather than killing or reducing the population of microbes.

Specific examples of useful microbiocide components include, without limitation: 5-chloro-2-methyl-4-isothiazolin-3-one; 2-methyl-4-isothiazoline-3-one; methylene-bis(thiocyanate); sodium dimethyldithiocarbamate; disodium ethylene-bis-dithiocarbamate; trichloro-s-triazinetrione (trichloroisocyanurates); n-alkyl dimethyl benzyl ammonium chloride; bis(tri-n-butyltin)oxide; poly(oxyethylene(dimethyliminio))ethylene(dimethyliminio-ethylene dichloride); 1-bromo-3-chloro-5,5-dimethylhydantoin; 1,3-dichloro-5,5-dimethylhydantoin; 1,3-dichloro-5-ethyl-5-methylhydantoin; and the like and mixtures thereof.

In one embodiment, the potability additive component comprises a microbiocide precursor component, or precursor component, which is effective, when released into water in a potable water system, in interacting, for example and without limitation, in chemically reacting or to chemical react, with a substance present in the water in the potable water system, thereby providing the water in the potable water system with an enhanced anti-microbial activity relative to the water in the potable water system without the release of the precursor component. The microbiocide precursor component may comprise any suitable component which functions as such as described elsewhere herein. Examples of useful microbiocide precursor components include, without limitation, one or more ammonium-containing salts quarternary and/or quarternary ammonium salts effective to chemically react with halogen-containing components and mixtures thereof in the water in the potable water system, thereby enhancing the anti-microbial activity relative to the water in the potable water system without the release of the precursor component. Suitable microbiocide precursor components include, without limitation, water soluble materials which have no significant detrimental effect on the potability of the water in the potable water system being treated or on the performance of other materials in the potability additive compositions and/or the controlled release systems of the present invention.

In one embodiment, the microbiocide precursor component comprises an ammonium salt effective in the presence of chlorine to provide a chloramine, which is a highly effective microbiocide component. Another example of a useful microbiocide precursor component is a material which is a source of bromide ion that in the presence of chlorine to provide hypobromous ion, which is a highly effective biocide. The microbiocide or biocide provided by the precursor component, for example, in combination with chlorine, or other biocide present in the potable water system is often a more effective microbiocide or biocide than the chlorine or other biocide present in the potable water system.

The potability additive component may be in solid, granular or particulate form provided that it does not decompose or melt at processing temperatures. The additive component may be molded in the form of a pellet or tablet which may have either a spherical or irregular shape. The additive pellet or tablet should be of sufficient size to provide the steady controlled release of the additive components into the water of potable water systems over the desired period of time. Further, when the additive pellet or tablet is used in a filtering environment, it should be larger than the pores or orifices of the filter. Generally, a spherical pellet or tablet should have a diameter or length or maximum transverse dimension on the order of from about 1/32 inch to about 5.0 inch, preferably from about 2/32 inch to about 3 inch, more preferably from about ⅛ inch to about ½ inch, even more preferably about ⅜ inch.

The formation of the potability additive component into a pellet or tablet is dependent upon the mixture of materials contained therein. For example, when the potability additive component contains a sufficient amount of a dispersing agent or a mixture of dispersing agents, the dispersing agent or mixture also may function as a binder, thereby allowing the component to be molded or compressed directly into the form of a pellet or tablet. If the potability additive component does not compact well, a binder may or must be added to the additive component in order to mold or compress it into a pellet or tablet.

Suitable dispersing agents and binders include, without limitation, those materials which have no significant detrimental effect on the potability of the water in the potable water system being treated or on the performance of the potability additive compositions. Suitable binders include, for example, carboxymethylcellulose, sodium carboxymethylcellulose, corn starch, microcrystalline cellulose, sodium hydroxypropylcellulose, preferably hydroxyethylcellulose, and water.

Preferably, the potability additive component to be molded or compressed into a pellet or tablet further comprises a die release agent. Suitable die release agents include, without limitation, those materials which are compatible with the particular potable water system being treated and have no significant detrimental effect on the potability of the water in the potable water system being treated or on the performance of the potability additive compositions. Suitable die release agents include, for example and without limitation, calcium stearate, magnesium stearate, mono-and dicarboxylic acids, corn starch and the like and mixtures thereof.

Advantageously, the potability additive component is compatible with the controlled release component that substantially surrounds it and with the potable water system to be treated. For example, and without limitation, the potability additive component may be selected so as not to be unduly degraded or damaged by, and not to cause undue degradation or damage to, the controlled release component and the potable water system be treated. In addition, the potability additive component may be selected to be effective in enhancing the potability of water in the specific potable water system to be treated, for example, and without limitation, in controlling the population of the microbe or microbes, for example, the specific microbe or microbes, present in the potable water system to be treated.

In one embodiment, the controlled release component comprises a coating of a polymer, for example, a polymer which is soluble or insoluble in the water in a potable water system. The controlled release component may be in the form of a polymeric material obtained from polymer dispersion which can be used in making the present potability additive composition. If a polymer dispersion is employed, the following properties can be useful.

The polymer dispersion may have low to medium viscosity. When the viscosity is too high, it would become impossible to pump the polymer dispersion, for example, through a coating system, in making the potability additive compositions of the present invention. High viscosity polymer dispersions would plug the system. Also, in this case, the droplets of polymer dispersion would be too thick and difficult to lose moisture. Such high viscosity polymer dispersions would not form good and homogeneous coatings.

Reducing the viscosity of a polymer dispersion through dilution with water is not always a viable solution. Often the dilution leads to changes of physical properties for the polymer dispersion and renders the polymer not appropriate for coating applications.

Every polymer has its own characteristic film forming temperature and glass transition temperature, T_{g}. To form a good coating, the polymer must have a film forming temperature lower than the operating temperatures inside the chamber of the drum coater in the coating process. A high T_{g} would lead to a brittle and fragile film which may easily peel off. Generally, a polymer with lower film forming temperature and T_{g} forms better film than those polymers with higher corresponding temperatures.

In the early stage of coating process, the polymer has to have good adherence to the surface to be coated, so that the coating film can gradually build up. The polymer particles should pack well without large spaces or holes in between. This can be examined and confirmed under a microscope. Typically the polymer with small particle size will result in better packing. Also, the polymer advantageously possesses good elasticity; otherwise, the coating cracks, especially, for example, upon cooling.

Typically, the polymer advantageously is insoluble and stable in the potable water system, for example, in the water in the potable water system. In addition, the polymer is to have substantially no or no detrimental effect on the potability of the water in the potable water system.

In one embodiment, film forming polymers are found to have these desired properties. Suitable film forming polymers include, for example, homopolymers, copolymers and mixtures thereof, wherein the monomer units of the polymers are preferably derived from ethylenically unsaturated monomers, for example, two or more different such monomers.

In one embodiment, the coating comprises a polymeric component selected from (1) polymers including units, for example, repeating units, from one or more of vinyl acetate, ethylene, vinyl chloride and the like and mixtures thereof, (2) polymers including units, for example, repeating units, from one or more of vinyl acetate, an acrylate ester (acrylate), and at least one monomer selected from vinyl neopentanoate, vinyl neohexanoate, vinyl neoheptanoate, vinyl neooctanoate, vinyl neononanoate, vinyl neodecanoate and vinyl neoundecanoate and the like and mixtures thereof.

A number of polymers including units from one or more of vinyl acetate, ethylene and vinyl chloride have been found to be useful in the present invention. Not all polymers including units from one or more of these monomers are useful in the present invention. Useful polymers may include units from one or more other monomers.

In one embodiment, the presently useful polymers exhibit a viscosity low enough for coating processing without difficulties, for example about 300 to about 800 or about 1500 cps, have a glass transition temperature, T_{g}, sufficiently low, for example about 0° C. or lower, to facilitate forming a good coating, are provided in a fine to medium particle size for example, about 0.1 to about 0.5 micron, such as 0.17 micron in diameter forms elastic coatings, and are insoluble and stable in water of potable water systems.

The presently useful polymers including units from vinyl acetate, ethylene and vinyl chloride can be made using conventional and well known techniques. Therefore, such manufacturing techniques are not described in detail herein. In one embodiment, the polymer may be a water-based emulsion polymer. These polymers may vary in composition. For example, such polymers may include about 1% or less to about 50% or more by weight of units from vinyl acetate; about 1% or less to about 50% or more by weight of units from ethylene; and about 1% or less to about 50% or more by weight of units from vinyl chloride.

In a particularly useful embodiment, the coating comprises a water-based emulsion vinyl acetate-ethylene-vinyl chloride terpolymer, for example, such as sold under the trademark Airflex 728 by Air Products and Chemicals, Inc., Allentown, Pa., U.S.A.

Another group of suitable polymers for use in the present coatings are the polymers, such as terpolymers, including units from vinyl acetate, acrylate esters, including, for example, lower alkyl, such as alkyl containing 1 to about 6 carbon atoms, acrylates and lower alkyl methacrylates, and at least one of certain vinyl neoalkanoates. As used herein, the term “lower alkyl” includes methyl, ethyl, propyl, butyl, pentyl, hexyl and the like.

In one useful embodiment, a polymer included in the coating is made up of a polymer, for example, a terpolymer, including units from vinyl acetate, butyl acrylate and at least one of vinyl neopentanoate, vinyl neohexanoate, vinyl neoheptanoate, vinyl neooctanoate, vinyl neononanoate, vinyl neodecanoate and vinyl neoundecanoate. The vinyl neoalkanoate monomer may be vinyl neopentanoate. In another embodiment, the vinyl neoalkanoate monomer is vinyl neononanoate. In a further embodiment, the vinyl neoalkanoate monomer is vinyl neoundecanoate.

The presently useful vinyl neoalkanoates may be produced using conventional and/or well known techniques. Therefore, such production techniques are not described in detail herein. A number of the presently useful vinyl neoalkanoates are commercially available. For example, vinyl neoundecanoate is sold under the trademark VEOVA 11 by Shell Chemicals; vinyl neononanoate is sold under the trademark VEOVA 9 by Shell Chemicals; and vinyl neopentanoate is sold under the trademark VEOVA 5 by Shell Chemicals.

The presently useful polymers, for example, terpolymers, including units of vinyl acetate, at least one lower alkyl acrylate ester, and at least one of the vinyl neoalkanoates set forth herein can be made using conventional and well known techniques. Therefore, such manufacturing techniques are not described in detail herein. These polymers may vary in composition. For example, such polymers may include about 1% or less to about 50% or more by weight of units from vinyl acetate; about 1% or less to about 50% or more by weight of units from alkyl acrylate esters; and about 1% or less to about 50% or more by weight of units from the neoalkanoates set forth herein. In one embodiment, such polymer may be a water-based emulsion polymer.

In a preferred embodiment, an active polymer solid, for example, an active terpolymer solid, such as a polymer including units from at least one vinyl neoalkanoate, is provided in a dispersion including about 50% to about 57% or about 60% by weight of active polymer solid. Additionally, a surfactant may also be added to stabilize the dispersion.

To form a controlled release additive composition, the polymeric coating may be applied to the potability additive composition core by spray coating, microencapsulation or any other coating technique well known to practitioners in the art. In one embodiment, the polymeric coating is an aqueous dispersion latex which is applied to the additive core pellet or tablet by drum or pan coating. The amount of coating to be applied to the potability additive core is dependent upon the desired controlled release characteristics of the resulting coated tablet or pellet. An increase in the amount of coating will result in a decrease of the rate of release of the potability additive component. Generally, the weight percent of the coating is from about 1.0 to about 40.0% based on the total weight of the additive tablet, for example, from about 2% to about 20% by weight or about 3% to about 15% by weight. In one embodiment, the coatings of the controlled release potability additive compositions employed in potable water systems may be about 4% to about 10%, for example, about 8% by weight of the controlled release potability additive compositions.

In a further embodiment of the present invention, a controlled release system for releasing a potability additive component in a potable water system is provided. The controlled release system provides for the release, for example, the controlled release, of a potability additive component, as described elsewhere herein, into a potable water system. The controlled release system may comprise a container designed to provide gradual, or sustained, or otherwise substantially controlled, release of the potability additive component into the water of a potable water system, for example, a drinking water system.

In one embodiment, the present controlled release system comprises a water-impermeable casing defining a hollow interior, and at least one opening into the hollow interior; a potability additive component, for example, as described elsewhere herein, located in the hollow interior of the casing; and at least one element, for example and without limitation, a water permeable element, positioned in proximity to, for example and without limitation, at or near, the opening of the casing and effective in controlling the release of the potability additive component into the potable water system in contact with the casing.

The size and shape of the casing are not of critical importance, provided that the size and shape of the particular casing or container used in a particular application is sufficient or appropriate to allow the controlled release system to effectively perform the desired function, that is to provide for the desired release of a potability additive component into the potable water system, in the particular application. For example, and without limitation, the casings may range in size and shape from a bowl-shaped container about 3 inches or less to about 15 inches or more in length and about 2 inches or less to about 10 inches or more in diameter. The volume of the hollow interior of the casing may vary over a relatively wide range, for example, and without limitation, in a range of about 5 cubic inches or less or about 20 cubic inches to about 500 cubic inches or about 1500 cubic inches or more.

The casing, for example and without limitation, may have a generally cylindrical shape, a generally bowl shape or any of a large number of other shapes. The casing may have one or more curved and/or planar walls or it can have all curved or planar walls.

In general, the controlled release systems may be placed so as to contact the water in the potable water system to be treated. For example, and without limitation, the system may be placed in a pond or pool or lake of water (potable water or water to be treated to be potable or more potable) to be treated. The systems may be variously sized and shaped to facilitate placement to allow for contact with the water in the potable water system to be treated and release of the potability additive component into such potable water system.

The at least one opening in the casing may be provided at any location or locations in the casing. For example, such opening or openings can be located at the top and/or bottom and/or ends and/or side or sides of the casing, as desired. The choice of the location for the opening or openings often is at least partially based on the particular application involved, and/or the ease and/or the cost of manufacturing the present controlled release systems, and the like factors, and may have at least some effect on the performance effectiveness of the containers.

In order to illustrate and describe the present controlled release systems more clearly, cylindrically-shaped casings and bowl-shaped casings are emphasized herein. However, the casings of the present systems are not limited to such shapes and casings of other shapes are within the scope of the present invention.

In one embodiment, the casing may be cylindrical in shape, for example, having a first end and a second end. The casing is provided with at least one opening, for example at one or both of the first end and second end and/or in the side wall of the casing. The casing may be substantially bowl-shaped. For example, the bowl-shaped casing defines a hollow interior, a top, bottom and one or more side walls. The opening or openings can be located in the top, bottom and/or one or more side walls.

The potability additive component, for example, as described elsewhere herein, is provided in the hollow interior of the casing.

At least one element is provided at or near at least one opening of the casing. In one embodiment, an element advantageously is provided at or near each opening of the casing. Such element or elements are effective in providing for release of the potability additive component into the water in the potable water system in contact with the casing, for example, in a slow and/or sustained and/or otherwise substantially controlled manner over time, for example, while retaining the balance of potability additive component within the casing for release over a further amount of time.

The casings of the present controlled release systems may be made of any suitable material or materials of construction. The casing is advantageously chosen to have substantially no detrimental effect on the potability additive component or on the potable water system or on the potability of the water in the potable water system or on the performance of the present controlled release system. The casing may be constructed of any suitable material or combination of materials.

In one embodiment, the casing preferably is constructed of a material selected from metals, such as steel, aluminum, metal alloys and the like, polymeric materials, combinations thereof and mixtures thereof. In one useful embodiment, the casing is constructed of a material selected from metals, polyvinyl chloride (PVC), polyethylene (high density and/or low density), polypropylene (PP), nylon, polyethylene vinylacetate (EVA), polypropylene vinylacetate (PVA), polyethylene terephthalate (PET), polyester, acetal, polyphenylene sulfide (PPS), and the like, combinations thereof and mixtures thereof.

In a very useful embodiment, the present controlled release systems, for example, the casings of such systems, are structured so as to be not refillable with potability additive component, that is after the potability additive component originally placed in the hollow interior of the casing is released into a potable water system. For example, the present controlled release system may be structured to at least partially collapse as the originally present potability additive component is released from the hollow interior of the casing into a potable water system. Such non-refillable structure may involve sealing the casing shut after the casing is filled with the initial or original charge of potability additive component. Such sealing effectively prevents the refilling of the casing. Alternately, or in addition, the casing can be made of relatively thin and/or otherwise collapsible material so that as the potability additive component is released from the casing, the casing substantially irreversibly collapses, making refilling and reuse of the casing impractical, if not impossible.

Employing a non-refillable casing and/or a collapsible casing is particularly useful when the potability additive component comprises a microbiocide. Microbiocides often are highly toxic and can be dangerous to the health of people who handle such materials. Thus, using non-refillable and/or collapsible casings at least discourages, and even prevents the reuse of such casings, thereby protecting the health and safety of those who would seek to refill the casings, for example, with microbiocides.

In one embodiment, the at least one element of a present controlled release system, for example, comprising at least one membrane, such as a porous or water-permeable or semi-permeable membrane, facilitates or permits contact of water in the potable water system with the potability additive component provided within the casing. The element may be selected to have substantially no detrimental effect on the potability additive component or on the potable water system or on the water in the potable water system or on the performance of the present controlled release system.

If a membrane is employed, the system may include at least one membrane retention member or two or more retention members, for example, an open mesh screen, woven cloth and the like, effective in retaining the membrane in a substantially fixed position relative to, for example, within, the casing.

In one useful embodiment, the membrane may be adhered to the casing, for example, at or near the at least one opening of the casing, for example, so that the membrane extends across the entire opening. The use of membranes which are adhered to the casing is less mechanically complex, easier to assemble and less expensive to produce relative to a system in which the membrane is held in place by one or more retention members. Moreover, such adhered membranes are as effective or more effective and durable relative to membranes held in place by retention members.

The membrane may be made of any suitable material, such as a suitable water insoluble material. Examples of such materials include, without limitation, glasses, polyamides, such as nylon and the like, cellulosic polymers, such as cellulose acetate and the like, polyesters, polyethylene vinylacetate (EVA), polypropylene vinylacetate (PVA), polyvinyl chloride (PVC), polyurethanes, stainless steel mesh, sintered metals (such as sintered metal discs and the like), metal membrane filters (such as silver membrane filters and the like), and the like, and combinations thereof and mixtures thereof. In one embodiment, the membrane comprises a material selected from cellulose; cellulose salts, for example and without limitation, cellulose acetate, cellulose sulfate, cellulose phosphate, cellulose nitrate and the like and mixtures thereof; cellulose esters; polyesters; polyamides, glasses, and the like, combinations thereof and mixtures thereof.

The membrane can alternatively be a material through which a potability additive component can pass, for example, by diffusion (although not necessarily through pores), such as silicone rubber, polyethylene, polyvinylacetate, natural and synthetic rubbers, and other polymers and waxes, and the like, combinations thereof and mixtures thereof. Such membranes are often referred to as semi-permeable membranes. In one embodiment, a “semi-permeable membrane” refers to a continuous film of a material, for example and without limitation, a polymeric material, permeable to or wettable by water, which permits diffusion of molecules therethrough, for example and without limitation, through microscopic channels. The pore size of such a semi-permeable membrane may not be easily measurable and may be less than about 0.2 microns.

The membrane may have an average pore size within the range of about 0.2 microns or less or about 1 micron or about 2 microns to about 30 microns or about 40 microns to about 300 microns or more. As referred to herein, a “membrane” may be a single layer or may include multiple plies. The thickness of the membrane may be in a range of about 0.1 mm or less to about 0.5 mm or about 1 mm or about 5 mm or about 10 mm or more, although other thicknesses can be effectively employed. Specific examples of useful membrane materials include the filter medium sold by Fleetguard Division of Cummins Engine under the trademark STRATOPORE and filter media available from Whatman and Millipore.

The presence of and/or size of pores in the membranes employed in accordance with the present invention may or may not be the controlling factor in determining the rate of release of the potability additive component into the potable water system. Other factors which may be important, or at least have an effect, in determining the rate of release of potability additive component into the water in the potable water system include, but are not limited to, the membrane material of construction, the physical dimensions (for example, thickness, volume and the like) of the membrane, the presence and/or intensity (density) of the electrical charge, if any, on the membrane material, the potability additive component being employed, the degree of hydrophilicity/hydrophobicity of the membrane material, the form of the potability additive component and the like factors.

To illustrate, each of two membranes having the same physical dimensions is used in a different identical container containing the same amount of the same potability additive component in accordance with the present invention. Each container is used to release the potability additive component from the container into water in an identical manner and the rate of release of the potability additive component is measured. One membrane is formed of cellulose nitrate, a material having a relatively high degree of polarity, having an average pore size of 20-25 microns. The other membrane is formed of a relatively low polarity glass having an average pore size of only 5 microns. However, the glass membrane, having the smaller pores, is found to have a higher or increased potability additive component release rate relative to the cellulose nitrate membrane.

Thus, a number of factors may be considered in choosing or selecting the membrane material to be used in accordance with the present invention to achieve the desired potability additive component release rate. In one embodiment, the material of construction of the membrane and the pore size of the membrane are selected to control the rate of release of the potability additive component into the potable water system.

The potability additive component release flux rate through the membrane is defined as milligrams of potability additive component released per hour through one square millimeter of membrane or mg./hr./mm². Because the release flux rate varies over a wide range and is at least sometimes relatively slow, a test using benzyltriazole has been developed to quantify certain release flux rates that may be useful in accordance with the present invention. This test is conducted as follows.

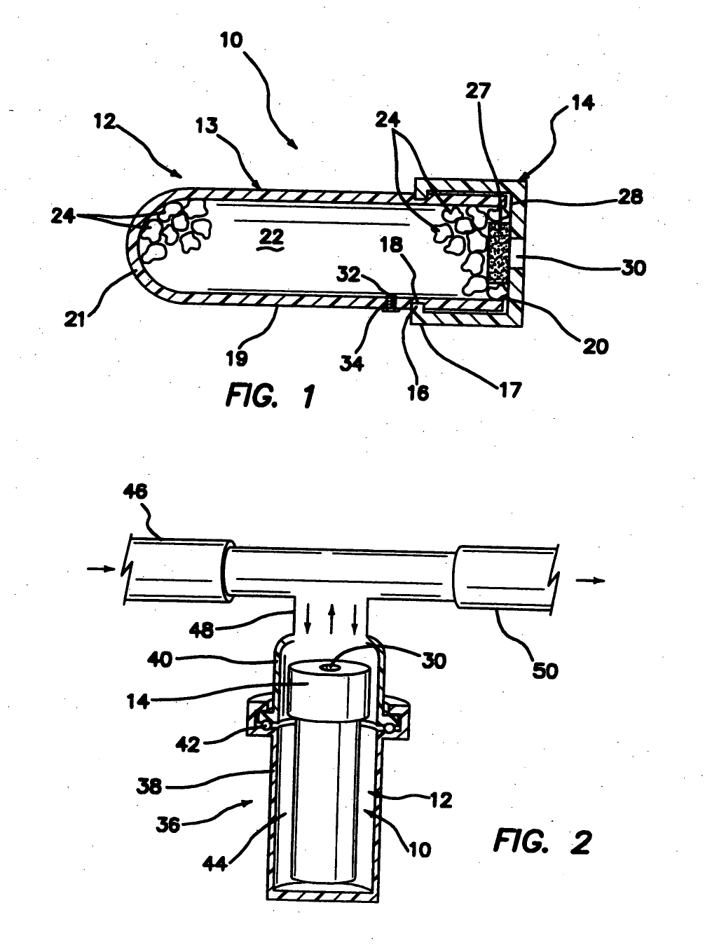

A tank with twenty (20) gallons of tap water is provided, together with a recirculating heater to give mixing and temperature control. The temperature is set to 80° F. Once this temperature is reached, a container, such as shown in FIG. 1, containing benyzyltriazole is placed in the tank in contact with the water. Water samples are collected at regular intervals over a 100 hour period and are measured for benzyltriazole content. From these measurements, the benzyltriazole release flux rate of the membrane is determined. To illustrate, suppose 300 mg of benzyltriazole is released through 351 mm² of membrane area (exposed through an opening in the outermost wall of the container) in 100 hours. The benzyltriazole release flux rate is 0.0085 mg./hr./mm².

Useful benzyltriazole release flux rates for membranes in accordance with the present invention may be in a range of about 0.001 or less to about 0.3 mg./hr./mm² or more, for example, in a range of about 0.002 to about 0.2 mg./hr./mm².

It should be noted that benzyltriazole release flux rates may be employed as one measurement of whether or not a membrane is useful in accordance with the present invention. However, the benzyltriazole release flux rate is not the only basis on which the usefulness of a particular membrane can be measured, determined or estimated. For example, prototyping may be employed, and other tests using the actual membrane and/or actual potability additive component to be used may be employed. Benzyltriazole release flux rates which are either too high or too low do not necessarily preclude the membrane tested from being useful in accordance with the present invention. There may be potability additive components that do not release sufficiently through membranes that have benzyltriazole release flux rates which are considered acceptable, or that release sufficiently through membranes that have benzyltriazole release flux rates which are not considered acceptable. In any event, within the limitations noted above, the benzyltriazole release flux rate has been found to be one useful tool in determining the suitability of membrane materials described in the container based controlled release component of the present invention.

In the event that a selected material is insufficiently rigid or stable under the conditions at which the present apparatus are used, a more thermoresistant material, such as one made of ceramic, glass and the like, combinations thereof and mixtures thereof, can be employed as a membrane material of construction.

The membrane may be secured to the casing so as to cover, for example, completely cover, the opening or openings in the casings, for example, so that no potability additive component passes outside the casing without passing through the membrane. The membrane advantageously is positioned in and/or directly adjacent the opening or openings in the casing. The membrane may be adhered to the casing, using an appropriate and compatible adhesive that does not detrimentally affect the potability of potability water system, press fitted to the casing, interference fitted to the casing or otherwise fixedly secured to the casing.

In one embodiment, the casing defines only one opening in an outermost wall of the casing and the membrane is provided in or directly adjacent the only one opening.

As noted above, in one embodiment, the water-permeable element further comprises at least one retention member. For example, the membrane may be retained across the opening of the casing by one or more wire or mesh screens, for example, stainless steel mesh screens. The membrane may be sandwiched between at least two retention members. The retention members preferably are structured, for example, so as to have a mesh size, to facilitate or permit the potability additive component from the casing to be passed, for example, by diffusion, into water of the potable water system in contact with the container. For instance, the retainer member or members preferably have a mesh size in the range of about 10 to about 300 microns or about 500 microns or more. A particularly preferred retention member is metal, e.g., stainless steel screening and/or woven cloth.

The potability additive component provided within a container of the invention may be effective when released into the potable water system to control, for example substantially prevent, substantially maintain, or reduce, unwanted microbial growth in the potable water system. The potability additive component may be provided in the form of a liquid, gel, paste or solid particles, for example, beads, tablets, pellets or grains, and the like, as well as mixtures thereof, within the casing.

The potability additive component of the invention may further comprise a coating material that at least partially surrounds or encapsulates or coats the potability additive component, as discussed elsewhere herein. Such coating material may be provided in order to at least assist in controlling, or to control, the release of potability additive component, as desired. The coating material may be either water-soluble or water-insoluble. In one very useful embodiment, the coating is water insoluble at the conditions of use, for example, to avoid contaminating the water in the potable water system being treated. The coating on the potability additive component should be such as to allow or permit at least some release of the potability additive component from the casing into the potable water system. Examples of useful coatings are set forth elsewhere herein.

The potability additive component of the present invention may include or may be located in a binder material and/or a matrix material, for example, a water-insoluble binder material and/or matrix material, such as a water-insoluble polymeric material. Suitable binder and/or matrix materials are water-insoluble materials which have no significant detrimental effect on the potability of the water in the potable water system being treated, on the potability additive component or on the performance of the present controlled release systems.

Examples of such binder materials and matrix materials include, without limitation, the binder materials set forth elsewhere herein.

The binder material and/or matrix material, if any, should be such as to allow or permit release of the potability additive component from the casing into the potable water system. The binder material and/or matrix material advantageously is effective to at least assist in controlling, or to control, the release of the potability additive component into the potable water system.

In one embodiment, the potability additive component may be present in the casing and no coating and/or binder material and/or matrix material is employed.

In one embodiment, the element or elements of the present controlled release systems may include a polymer-containing membrane, for example, a polymer-coated membrane, in order to achieve enhanced potability additive component release control. The membrane may be suitably coated, impregnated or otherwise associated, for example, by spray coating, dip coating and the like, with a polymer material.

Suitable polymer materials include, without limitation, water-insoluble materials which have no significant detrimental effect on the potability of the water in the potable water system being treated, on the potability additive component or on the performance of the present controlled release systems. Examples of such coating materials include those that are set forth elsewhere herein and those polymeric coating materials disclosed in Mitchell et al U.S. Pat. No. 6,010,639 and Blakemore et al U.S. Pat. No. 6,878,309.

In one embodiment, the polymer material is an ethylene/vinyl acetate copolymer.

In addition, or alternatively, the present retention member(s), if any, of the element or elements can be coated, impregnated, or otherwise associated with a material, for example, a water-insoluble polymer material, such as those that are set forth elsewhere herein and those disclosed in the above-noted patents, to at least assist in controlling or to control, the release of the potability additive component from the casing, as desired.

The casings of the controlled release systems may be filled with a potability additive component through the opening or openings of the casing or otherwise.

The casings may include one or more water-impermeable cap members or water-impermeable plugs, which can be detachable or removable from the casing or the remainder of the casing, for example, to facilitate filling the interior space of the casing with a potability additive component. Such casings are made of materials which are not significantly detrimental to the potability of the water in the potable water system being treated, to the potable water system or to the effective functioning of the controlled release system in the potable water system.

In a useful embodiment, the casings may include a further opening into the hollow interior; and a structure may be included and be operatively coupled to the further opening. This structure may be operable to allow at least one or both of the following: (a) air to pass out of the hollow interior through the further opening; and (b) water to pass into the hollow interior through the further opening.

The present controlled release systems are very useful in potable water systems wherein water is to be passed into the hollow interior of the casing to facilitate release of the potability additive component into the potable water system external from and/or in contact with the casing. In other words, the further opening and structure, as described herein, facilitate allowing and/or are effective in allowing, air to leave the hollow interior while water enters the hollow interior. Such configuration is particularly useful in applications in which the potability additive component comprises a microbiocide.

In one embodiment, the structure comprises a removable-plug structured to be placed in the further opening to close the further opening. For example, the container may include a removable plug in a further opening or port in the casing, which plug can be removed to allow water to be introduced into the hollow interior through the further opening to wet the potability additive component, for example, a microbiocide-containing potability additive component.

Certain potability additives, for example, certain microbiocides, are hydrophobic and/or otherwise resist wetting by water in contact with the casing. In such instances, it is advantageous that water be directly introduced into the hollow interior to wet the potability additive component and facilitate the initial release of the potability additive component into the potable water system. In other words, without such direct introduction of water, such a potability additive component in the hollow interior resists wetting by the water in contact with the casing for an overly long period of time so that, during this long period of time, no potability additive component is released into the potable water system. In effect, pre-wetting such potability additive components allows for a reasonably prompt, and controlled release of the potability additive component into the water in the potable water system in contact with the casing. Once the water has been directly introduced into the hollow interior, the plug may be repositioned in the further opening to close the further opening.

The structure may comprise a valve operable between a first position to allow air to pass out of the hollow interior through the further opening and a second position to substantially prevent air from passing out of the hollow interior through the further opening. As air leaves the hollow interior, water, may be introduced into the hollow interior, for example, through the further opening, to displace the air that has been removed. The valve may be located substantially within the hollow interior or substantially external of the hollow interior.

Any suitable valve may be employed as the structure in accordance with the present invention. Such valve should be operable and effective at the conditions at which the container is used, and should be made of materials which are compatible, that is materials which do not cause or create or have any undue or significant detrimental effect on the container during storage or use or in the potable water system or on the potability of the potable water system being treated. Examples of useful valves include, without limitation, ball float valves, spring loaded valves, duck bill valves, umbrella valves and the like. The valve may be adjustable so that the internal pressure within the hollow interior, for example, produced by water entering the hollow interior can be controlled by adjusting the valve to obtain a desired internal pressure before the valve is opened to allow air to leave the hollow interior through the further opening in the casing.

In one embodiment, the structure may comprise an air permeable membrane member positioned over the further opening. The air permeable membrane member is structured and positioned to allow air to pass out of the hollow interior through the further opening and to substantially prevent water from passing out of the hollow interior through the further opening.

The air permeable membrane member may be positioned in or covering the further opening, for example, using adhesives and/or other attachment means and/or by being interference fitted in the further opening.

The air permeable membrane member may be made of a material and/or may have properties such that the air permeable membrane member allows air to escape the hollow interior but not water. For example, the air permeable membrane member may be made of a non-wetting material and/or have a size and porosity sufficiently lower than the water permeable membrane described elsewhere herein to effectively not contribute to the release of the potability additive component through the air permeable membrane member. For example, the water permeable membrane may have a porosity of about 20 to about 30 microns and an area of about 40 cm² or less to about 60 cm² or more and the air permeable membrane member may have a porosity of about 1 to about 10 microns and an area of about 1 cm² to about 10 cm² or more.

The air permeable membrane member may be made of any suitable material, for example, sufficiently durable to be effective in use with the present container and compatible with the remainder of the container and the potable water system being treated.

In a further embodiment, with the container including an opening, primarily for the release of potability additive component into the potable water system and a further opening, the same membrane material may be used to cover both the opening and the further opening. For example, and without limitation, in a case where 51 cm² of total area is needed to get the desired release of the potability additive component from the hollow interior, the opening would be larger, such as at least about 5 times larger in area, for example, about 45 cm², than the further opening, for example, about 6 cm². The larger opening may be placed, below, or down stream of, or above, or upstream of, the smaller, further opening. In this embodiment, the membrane material employed to cover both the opening and the further opening may be suitable as a material for the water permeable membrane member.

In one embodiment, it is highly advantageous that the membrane material or materials employed to cover both the opening and the further opening be wetted, inside and outside, for example, by water in the potable water system being treated. In the event one of the different membrane materials is less wettable than the other membrane material, than it is advantageous to have that less wettable membrane material cover the upstream or top opening and to be as small as possible so that the variation in performance, due to the reduced wettability of this membrane material, from application to application is reduced.

In one embodiment of the present invention wherein the casing is substantially cylindrical shaped and the opening or openings are located at the end or ends of the casing, one or both ends of the casing may include a cap member, with at least one of the cap members being removable to allow the casing or cartridge to be filled or refilled with a potability additive component. Another open end of the casing, if desired, may include a cap member that is permanently sealed thereto, for example, during manufacture, for example, during injection molding of the container. Whenever the cap or plug is attached by threading or screwing it onto the casing, screw threads can be applied to the respective pieces during or after molding with suitable dies or within the mold. The cap member can alternatively be applied to the casing by a press fit. In this case, suitable tolerances to make a snap fit between the casing and the end piece can be provided, for example, to the plastic injection molds used to make the respective pieces. The end piece can also be formed integrally with the casing, e.g., during injection molding.

The cap or end piece used to close at least one end of the casing containing the potability additive component typically is provided with at least one opening to permit release of the potability additive component therethrough, and to provide fluid communication between the water located exterior to the controlled release system and the potability additive component disposed within the casing interior. Whenever an end piece is formed integrally with the casing, the opening can be provided therein during or after formation of the casing, for example, by injection molding.

It will be appreciated by those of skill in the art that release of the potability additive component into a potable water system utilizing a controlled release system described as above is provided, and the release rate may be substantially controlled by consideration of several factors. The following factors, as well as others, may also have an effect on the performance and effectiveness of the controlled release system of the present invention. For example, a desired potability additive component release rate may be obtained by appropriate selection of: the number and type of membrane layers; membrane composition; membrane pore size, if any; the presence, type and amount, if any, of polymer associated with, e.g., coated, on the membrane; and the presence, type and amount, if any, of the coating on the potability additive component. The rate of release may also be influenced by the number and size of openings in the casing and the like. Other factors to be considered include, among others, the type and form of the potability additive component, the solubility of the potability additive component in the potable water system to be treated, the temperature of the potable water system to be treated, and the velocity of the potable water system through the potable water system line or system to be treated and the like factors.

Further contemplated within the invention is a method for releasing a potability additive component, preferably at a controlled rate, into a potable water system. The method comprises placing in contact with the potable water system a controlled release system, as described elsewhere herein, containing the potability additive component. The controlled release system, as described elsewhere herein, advantageously permits a release, preferably a controlled release, of potability additive component from the casing interior into the potable water system. It is contemplated that, in some configurations, the potable water system is permitted to flow around and encircle the casing containing the potability additive component. However, even in these configurations, release of potability additive component is preferably sustained and/or controlled, for example, by diffusion, for example, passive diffusion, rather than by forced flow of water in the potable water system through the casing.

The potability additive component for use in a casing may be provided as a liquid, gel, paste or as particles, for example, beads, tablets, pellets, grains, coated versions of these, and the like, as well as mixtures thereof. In one embodiment, the particles have a physical size large enough to prevent passage through the water-permeable elements of the controlled release systems as described elsewhere herein.

The potability additive component is often present in an amount of at least about 30% by weight of the material present in the hollow interior of the casing. Advantageously, the potability additive component is present as a major amount, that is at least about 50% by weight, of the material in the hollow interior of the casing. The potability additive component may be at least about 70% by weight or at least about 90% by weight or more of the material present in the hollow interior of the casing.

Any suitable, for example and without limitation, effective, potability additive component may be employed in accordance with the present invention. In one useful embodiment, the potability additive component is an U.S. Environmental Protection Agency (EPA) registered microbiocide component or is included in an U.S. EPA registered microbiocide composition. In another useful embodiment, the potability additive component is an U.S. FDA registered microbiocide component or is included in an U.S. FDA registered microbiocide composition.

The amount of potability additive component released by the present controlled release systems into the potable water system depends on one or more of a number of factors, for example and without limitation, the particular potable water system to be treated, the degree and/or type of treatment desired for the particular potable water system to be treated, the particular microbe or microbes to be controlled, the extent of microbial growth or population reduction to be controlled, the configuration and/or size and/or operating conditions of the potable water system and the like factors. The effective concentration of the potability additive component in the potable water system may vary over a wide range depending on a number of factors, for example, including one or more of the same factors set forth in this paragraph. Such concentration may range from about 0.0001% by weight or less to about 0.5% by weight or more of the water in the potable water system. Useful potability additive component concentrations may be in a range of about 0.0001% or about 0.001% to about 0.01% or about 0.1% or about 0.5% by weight of the water in the potable water system. Useful potability additive component concentrations when the potability additive component is a microbiocide component may be in a range of about 0.1 ppm or less to about 10 ppm or more by weight of the water in the potable water system.

The controlled release systems of the present invention can be placed at any suitable location in a potable water system, for example and without limitation, in a potable water system filter, for example, either upstream or downstream of the filter medium, or it can be placed in a position or location in which the water in the potable water system is used or employed separate and apart (spaced apart) from potable water system filter, or it can be provided in a substantially fixed position in a potable water system line, either upstream or downstream of the potable water system filter.

The following non-limiting examples illustrate certain aspects of the present invention.

### Example 1

Using a conventional drum coater, a particulate potability additive component, in particular, a microbiocide compatible with the potable water system to be treated, is placed onto the rotating pan inside the drum coater. While the pan is being rotated, a commercially available dispersion of a vinyl acetate/vinyl versatate copolymer sold under the trademark EMULTEX VV575 by Harlow Chemical Co. (England) is pumped and sprayed through a nozzle onto the surfaces of the potability additive component. The spray rate and spray pattern is controlled to give a good mist of polymer droplets.

At the same time, through a very slightly reduced pressure, a stream of warm air at about 40° C. is passed through the coating chamber to remove the water vapor from the polymer mist (or small droplets), before and after they reach the surfaces of the tablets.

With time, the polymer gradually forms a layer of coating on the particles of potability additive component. After all the polymer dispersion is sprayed to reach the desired thickness of coating, the resulting coated potability additive composition is allowed to stay on the rotating pan for a few more minutes, then decanted from the pan into a container for storage.

### Example 2

A potability additive composition coated with a terpolymer including units of vinyl acetate, butyl acrylate, and vinyl neoundecanoate is made in a manner substantially similar to that described in Example 1.

### Example 3

A potability additive composition coated with a terpolymer including units of vinyl acetate, butyl acrylate, and vinyl neopentanoate is made in a manner substantially similar to that described in Example 1.

### Example 4

A potability additive composition coated with a terpolymer including units of vinyl acetate, butyl acrylate, and vinyl neohexanoate is made in a manner substantially similar to that described in Example 1.

### Example 5

A potability additive composition coated with a terpolymer including units of vinyl acetate, butyl acrylate, and vinyl neoheptanoate is made in a manner substantially similar to that described in Example 1.

### Example 6

A potability additive composition coated with a terpolymer including units of vinyl acetate, butyl acrylate, and vinyl neooctanoate is made in a manner substantially similar to that described in Example 1.

### Example 7

A potability additive composition coated with a terpolymer including units of vinyl acetate, butyl acrylate, and vinyl neononanote is made in a manner substantially similar to that described in Example 1.

### Example 8

A potability additive composition coated with a vinyl acetate-ethylene-vinyl chloride terpolymer is made in a manner substantially similar to that described in Example 1.

### Examples 9-16

Potability additive compositions from each of Examples 1 through 8 are independently placed into potable water systems, for example, in holding ponds.

It is determined that, in each case, the potability additive component is released gradually with time from the potability additive composition into the potable water system to effectively control the population of one or more microbes in the water in the potable water system. Furthermore, the release rates for the potability additive components are generally inversely proportional to the percentages or amounts of coatings included in the compositions. Potability of the water in the potable water system is achieved, maintained or enhanced in each of these tests.

These tests demonstrate that the controlled release potability additive compositions tested are useful in achieving, maintaining or enhancing potability of water in potable water systems.

### Example 17

Referring now to FIG. 1, a controlled release system 10 comprises a PVC casing 12 including a solid, open ended, generally cylindrically shaped casing body 13 and an end cap 14, which are fitted onto the casing body using a pair of pegs 16, inwardly extending from an end 17 of the cap 14, fitted into an annular groove 18 in the outer sidewall 19 of the casing body. The casing body 13 has an open end 20 and an opposing closed end 21. The casing 12 defines a hollow interior 22.

Provided within the hollow interior 22 are particles 24 containing only a microbiocide component. No other additive is included within the hollow interior 22. The microbiocide component, for example, 2,2-dibromo-3-nitrilonproprionamide (DBNPA), is effective to control, for example, substantially prevent, microbial growth in potable water systems in contact with the container 10.

A porous membrane 27 is adhered to the inner wall 28 of the end cap 14 and covers an opening 30 provided in the end cap. The membrane 27 is made of cellulose nitrate and has an average pore size in a range of about 20 to about 25 microns. The benzyltriazole release flux rate, as defined herein, is about 0.049 mg/hr/min². An adhesive is located between, and in contact with both, the inner wall 28 and the membrane 27, and is used to adhere the membrane 27 to the end cap 14. The adhesive 27 is such as to be insoluble and remain effective as an adhesive in the potable water system to which the membrane is to be exposed. The adhesive should also be compatible with such potable water system and potability additive component, microbiocide component, present in container 10, for example, have no significant or undue detrimental effect on such potable water system and the potability of the water included therein or on the potability additive component or on the other components of container 10. Examples of useful adhesives include, without limitation, epoxy resins; phenolic resins; acrylic resins; cyanoacrylate resins; silicone adhesives; polyurethane adhesives; hot melt adhesives, such as poly(ethylene vinyl acetate (EVA)), polyamide resins, polyester resins and the like; contact adhesives, such as those based on rubber, styrene resins and the like; and the like and combinations thereof.

The system 10 may be placed in a bag or other protective enclosure or packaging for shipment/storage.

The opening 30 in end cap 14 may have a diameter which varies over a relatively wide range, for example in a range of about 1 mm or less to about 50 mm or 80 mm or more. In one embodiment, the opening has a diameter in a range of about 2 mm to about 20 mm or about 40 mm, for example, about 8 mm to about 10 mm. Of course, the opening need not be circular, but can be other shapes, for example, square, rectangular, polygonal, etc. Advantageously, openings with other than circular configurations may have areas which substantially correspond to circular openings having diameters as noted herein; in particular, in a range of about 0.7 mm² or less to about 2000 mm² or 5000 mm² or more; or about 3.0 mm² to about 350 mm² or about 1250 mm², or about 5.0 mm² to about 80 mm² or about 300 mm².

The opening 30 in the end cap 14 permits the water in the potable water system to contact and possibly wet and/or pass through the porous membrane 27 in the casing 12. Release of the potability additive component, from the particles 24 through the membrane 27 by diffusion permits incorporation of the potability additive component in the water in the potable water system and its circulation throughout the water in the potable water system.

Advantageously, porous membrane 27 is effective to be wetted by the water in the potable water system and to permit the potability additive component from particles 24 to exit system 10 through membrane 27 and opening 30.

A removable plug 32 is located in port 34 of casing body 13. The plug 32 is structured to be removed to allow water, for example, from a potable water system to be introduced directly through port 34 into the hollow interior 22 of the casing 12 to contact and wet the particles 24 of the potability additive component contained therein.

Such water introduction directly into the hollow interior 22 is particularly advantageous in situations in which the potability additive component is resistant to being wetted by water in contact with the container 10.

Other means for introducing water into the hollow interior 22 to achieve such pre-wetting of the potability additive component may be employed. For example, water can be injected into the hollow interior 22 through a needle or similar device. Other systems for passing water through the membrane 27 into the hollow interior 22 may be employed. In the event such other means of pre-wetting the potability additive component in hollow interior 22 are employed or no pre-wetting of the potability additive component is desired, the casing body 13 need not include port 34 and plug 32.

For a container 10, six (6) inches in length having a 1.5 inch inner diameter, the amount of potability additive component particles 24 inside the casing is about 186 mL or about 175 g. Of course, the size of the container can be varied, as appropriate to include different amounts of potability additive component, for example, from about 15 g or less to about 500 g or more. Release of effective amounts of potability additive component starts in less than about 24 hours.

In one embodiment, the container 10 is structured so as not to be refillable with potability additive component. For example, and without limitation, the casing body 13, may be made of a lightweight and/or thin polymeric material, such as a thermoplastic polymeric material, which is sufficiently flexible and/or deformable so that, as the potability additive component is released from the casing body into the water, the casing body collapses, and remains collapsed. Such a collapsible casing body effectively prevents the refilling of the casing body with potability additive component, for example microbiocide component. Alternately, or in addition, the end cap 14 may be permanently sealed to the casing body 13 to prevent the refilling of the interior space 22 with potability additive component.

Such a non-refillable casing body is a substantial safety feature in accordance with the present invention. Thus, potability additive components, such as microbiocide components are often toxic, for example, as particles in an undiluted state, so that great care must be taken in handling such materials to avoid serious harm to the person or people handling the potability additive components. By using a non-refillable casing or casing body, such as a collapsible or sealed casing or casing body, it becomes clearly evident that such casing or casing body cannot be refilled with potability additive components. Therefore, the user does not even attempt to refill the casing with potability additive components, and, therefore, avoids the danger or risk of being seriously harmed or injured by the potability additive component.

### Example 18

As shown in FIG. 2, system 10 is positioned in vertical alignment with cylindrical housing 36 provided in a “bypass” configuration with potable water system. A representative diameter for the opening 30 in end cap 14 is 9 mm, and can range, for example, up to 51 mm or larger in diameter. As shown, housing 36 includes a housing body 38 and a housing top 40 which interlock to secure the container 10 within the housing 36. A housing O-ring seal 42 is provided between housing body 38 and housing top 40 to seal the interior space 44 of housing 36.

Water in a potable water system flows from inlet line 46, enters and exits housing 36 through pipe segment 48, and exits via exit line 50. While inside housing 36, the water passes through opening 30, wetting membrane 27 (not shown in FIG. 2) and facilitates the release, for example, through diffusion, of potability additive component from the particles 24 in casing 12 into the water in the potable water system. Generally, water flows into the inlet line 46 by the action of a water pump (not shown) of the potable water system, it being understood that gravity may also play a role. In addition, a filter element (not shown), for example, of conventional and well known design, may be located in exit line 50. It is understood that such filter element could alternatively be located in inlet line 46. Such alternative is included within the scope of the present invention. In one embodiment, the system 10 is structured for use independently of any filter or filtration system.

In addition, as shown in FIG. 2, the system 10 is situated in the housing 36 with the opening or orifice 30 facing upward, toward the pipe segment 48. Such an upward orientation is particularly useful if the particles 24 are coated (such as in Examples 1-16) and/or otherwise include a delayed release component to control or at least assist in controlling the release of the potability additive component from the system. Alternately the system 10 can be situated in the housing 36 so that the opening 30 is facing downward or away from the pipe segment 48. This downward orientation is particularly useful when the potability additive component in the particles 24 is not coated or combined with a delayed release component. Both the upward and downward orientations of the container 10, as well as side-to-side and other orientations of system 10, are included within the scope of the present invention.

### Example 19

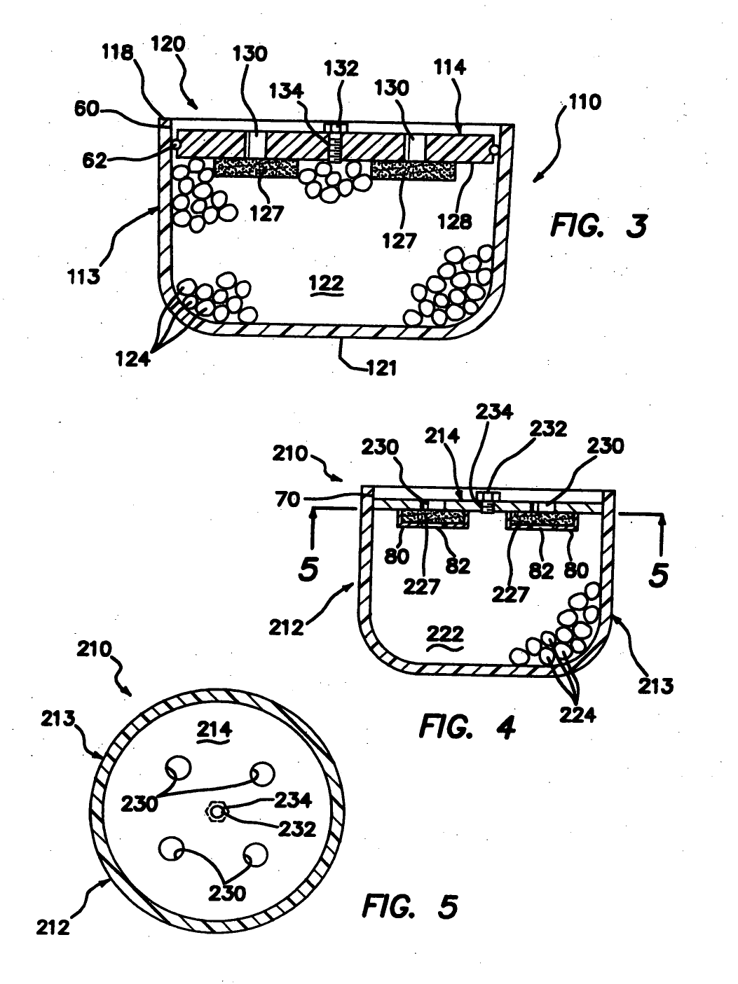

Turning now to FIG. 3, an additional controlled release system 110 of the present invention is shown. Except as expressly described herein, additional system 110 is structured and functions substantially similarly to system 10.

The system 110 generally comprises a bowl-shaped, water-impermeable casing body 113 having a hollow interior 122 filled with particles 124 of a United States Food and Drug Administration (FDA) registered microbiocide (for use in potable water systems), and one or more additives effective, when released into a potable water system to benefit the potability of water in the potable water system. The casing body 113 has a relatively wide open top end 120 which is, for example and without limitation, circular in shape, and an opposing closed end 121. The system 110 further comprises a cap member 114 disposed across, and preferably substantially completely covering, the open end 120.

The system 110 is useful in a potable water system line, for example. For example, system 110 may be placed in a potable water system, for example, in a manner substantially analogous to that shown in FIG. 2.

In the system 110 shown in FIG. 3, the cap member 114 is removably secured to the casing body 113 in order to allow for filling and/or refilling of the container 110 with the particles 124 of potability additive component. As shown, the cap member 114 may be recessed from a periphery, or rim 118, of the casing body 113.

The cap member 114 may be secured to an interior surface 60 of the casing body 113 by means of a resilient O-ring 62 or the like.

The cap member 114 includes at least one opening 130, preferably a plurality of openings 130, for example, four openings 130 as shown in the embodiment in FIG. 3, to allow water in contact with the system 110 to wet the porous membrane layers or pads 127. In this embodiment, the membrane layers 127 are made of cellulose nitrate having a pore size of about 8 microns, and a benzyltriazole release flux rate, as defined herein, of about 0.025 mg/hr./mm². It should be noted that useful release rates may vary widely, and be included within the scope of the present invention, for example, because the water flow varies so widely in various potable water systems, for example, from a ½ inch pipe in a house to a 24 inch main in a utility.

The membrane layers 127 are adhered to inner wall 128 of the cap member 114. Each layer or pad 127 completely covers a different opening 130 provided in the end cap 114. The adhesive used may be as described elsewhere herein. The membrane layers or pads 127 are provided for controlling release of the potability additive component from particles 124 into the water of potable water system.

In addition, a removable plug 132 is located in port 134 of cap member 114. The plug 132 is structured to be removed to allow water to be introduced directly through port 134 into the hollow interior 122 of the casing 112 to contact and wet the particles 124 of potability additive component contained therein. Such water introduction directly into the hollow interior 122 is particularly advantageous in situations in which the potability additive component is resistant to being wetted by the water in contact with the container 110.

Container 110 functions in a manner substantially analogous to container 10, and is effective to release potability additive component from the container into the potable water system. A filter element may be employed in this embodiment in a manner analogous to that described in Example 18.

### Example 20

FIGS. 4 and 5 show another controlled release system 210 of the present invention that, except as expressly described herein, is structured and functions substantially similarly to controlled release systems 10 and 110.

The system 210 generally comprises a bowl-shaped casing body 213 defining a hollow interior 222 for containing particles 224 of a U.S. FDA registered microbiocide component. In addition, an aluminum plate member 214 is secured to the inner wall 70 of casing body 213 for retaining the microbiocide component particles 224 within the casing 212. The aluminum plate member 214 includes a plurality of openings 230, for example, four openings 230 as shown in FIGS. 4 and 5. The four openings 230 are arranged in a configuration similar to how the four openings 130 in system 110 are arranged.

Four individual support structures 80 are secured to plate member 214 directly below each of the openings 230. Each of these structures 80 has a through opening 82 and, together with the plate member 214, defines a compartment sized to accommodate a porous membrane segment 227 between the plate member 214 and the through opening 82. The porous membrane segments 227 are, thus, press fitted to plate member 214. Each of the membrane segments 227 covers, in particular, completely covers, a different one of the openings 230.

In addition, a removable plug 232 is located in port 234 of casing 212. The plug 232 is structured to be removed to allow water to be introduced directly through port 234 into the hollow interior 222 of the casing 212 to contact and wet the particles 224 of potability additive component, the microbiocide, contained therein. Such water introduction directly into the hollow interior 222 is particularly advantageous in situations in which the potability additive component is resistant to being wetted by the water in contact with the container 210.

System 210 can be used in a manner analogous to systems 10 and 110, and functions and is effective to release potability additive component from the hollow interior 222 into the potable water system. A water filter element may be employed in this embodiment in a manner analogous to that described in Example 18.

### Example 21

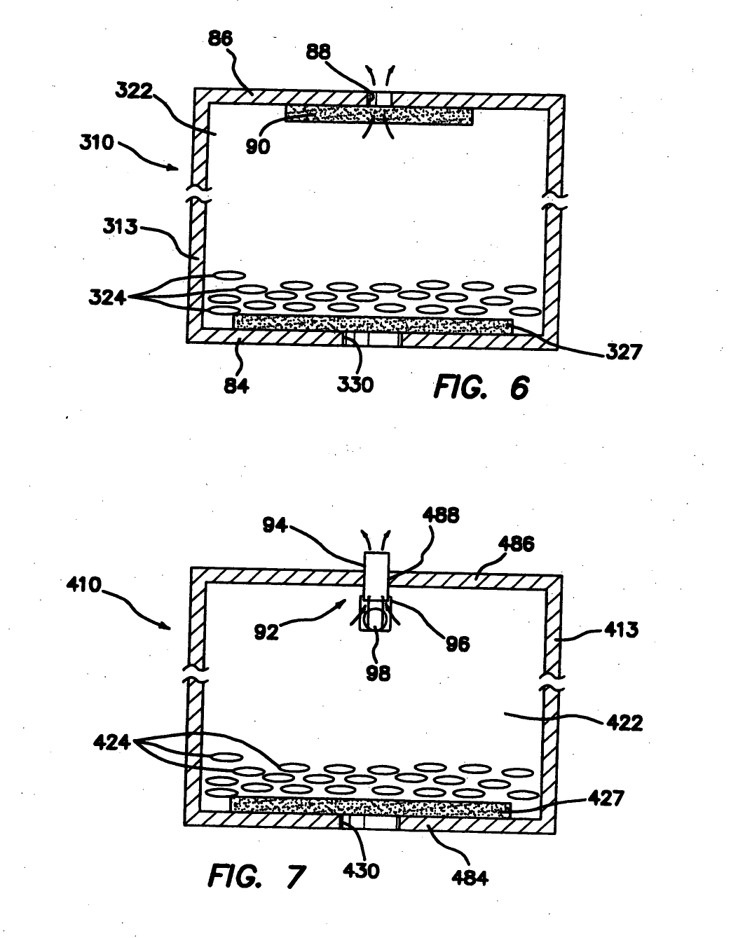

FIG. 6 shows a further controlled release system 310 of the present invention that, except as expressly described herein, is structured and functions substantially similarly to systems 10, 110, 210. The somewhat schematic character of FIG. 6 is meant to illustrate the distinguishing features of further system 310.

The system 310 generally comprises an elongated, cylindrical casing body 313 defining a hollow interior 322 for containing particles 324 of a U.S. FDA registered microbiocide component.

The casing body 313 includes a first end wall 84 defining a relatively large opening 330. A membrane filter member layer or pad 327 covers the opening 330 and is secured in place, that is secured to first end wall 84, by an adhesive, as described elsewhere herein.

The casing body 313 includes an opposing, second end wall 86 defining a relatively smaller second opening 88. A further membrane filter member layer or pad 90 covers, in particular completely covers, the second opening 88, and is secured in place, that is secured to second end wall 86, by an adhesive, as described elsewhere herein.

The ratio of the size or area of opening 330 to the size or area of second opening 88 may be in a range of about 2 or about 4 to about 12 or about 20, for example, about 10. In one embodiment, the ratio of the size or area of opening 330 to the size or area of the second opening 88 may be at least about 5. The ratio of the porosity of the membrane layer or pad 327 to the porosity of the further membrane layer or pad 90 may be in a range of about 1 or about 2 to about 10 or about 15.

The combination of the size of second opening 88 and the properties, for example, porosity, material type, electrical charge and the like, of the further membrane layer or pad 90 is such to allow air to escape the hollow interior 322 through second opening 88, and to substantially prevent water in the potable water system, from entering the hollow interior 322 through second opening 88. Membrane materials which may be employed in this embodiment may include, without limitation, cellulose nitrate membranes having average pore sizes of about 5, about 8 and about 20-25 microns.

System 310 may be placed in the potable water system with the opening 330 positioned below second opening 88, or with the opening 330 located downstream of second opening 88 in the event the water is flowing across system 310. As the system 310 becomes immersed in the water in the potable water system, the water passes through opening 330 and membrane layer or pad 327 into the hollow interior 322. As the water is so introduced into the hollow interior 322, air from inside the hollow interior exits through further membrane layer or pad 90 and second opening 88. The water and potability additive component 324 in the hollow interior 322 is substantially prevented from passing through further membrane layer or pad 90 and second opening 88.

System 310 functions in a manner similar to container 10 to effectively release the potability additive component from the container through opening 330 into the potable water system in which system 310 is present.

Since system 310 is structured to allow water to enter the hollow interior, the potability additive component is effectively wetted by the water, which wetting may be advantageous to facilitating a controlled or consistent, for example, substantially constant, rate of release of the potability additive component into the water of the potable water system.

### Example 22

FIG. 7 shows a valved controlled release 410 of the present invention that, except as expressly described herein, is structured and functions substantially similarly to systems 10, 110, 210 and 310. The somewhat schematic character of FIG. 7 is meant to illustrate the distinguishing features of valved container 410.

The valved system 410 generally comprises an elongated cylindrical casing body 413 defining a hollow interior 322 for containing particles 324 of an U.S. FDA registered microbiocide component, for example, as described elsewhere herein.

The casing body 413 includes a first end wall 484 defining a relatively large opening 430. A membrane filter medium layer or pad 427 covers the opening 430 and is secured in place, that the layer or pad is secured to first end wall 484, by an adhesive, as described elsewhere herein. The membrane layer or pad 427 is structured and functions similarly to membrane pad or layer 327.

The casing body 413 includes an opposing, second end wall 486 defining a second opening 488. A ball float valve, shown generally at 92, includes a valve port or conduit 94, a valve housing 96 and a ball 98 within the housing. The valve conduit 94 and valve housing 96 are secured together. The valve housing 96 and ball 98 are located internally within the casing body 413. The valve conduit 94 is secured, for example, interference fitted and/or by the use of an adhesive, to the casing body 413.

System 410 may be placed in a potable water system with the opening 430 below second opening 488, or with the opening 430 located downstream of second opening 488 in the event the water is flowing across system 410. As the system 410 becomes immersed in the water in the potable water system, the water passes through opening 430 and membrane layer or pad 327 into the hollow interior 422. As water is so introduced into the hollow interior 422, air from inside the hollow interior exits through valve conduit 94. Once the water level in the hollow interior 422 reaches a level about equal to that of the ball 98, the ball will float up against the valve conduit 94 and close the valve 92 to substantially prevent any flow of material into or out of hollow interior 422 across valve 92. Thus, the water and microbiocide component in the hollow interior 422 is substantially prevented from passing out of hollow interior 422 across valve 92.

System 410 functions in a manner similar to system 310 to effectively release the potability additive component from the system through opening 430 into the potable water system.

Since system 410 is structured to allow water to enter the hollow interior, the potability additive component is effectively wetted by the water, which wetting may be advantageous in facilitating a controlled or consistent, for example, substantially constant, rate of release of the microbiocide component into the potable water system.

### Example 23

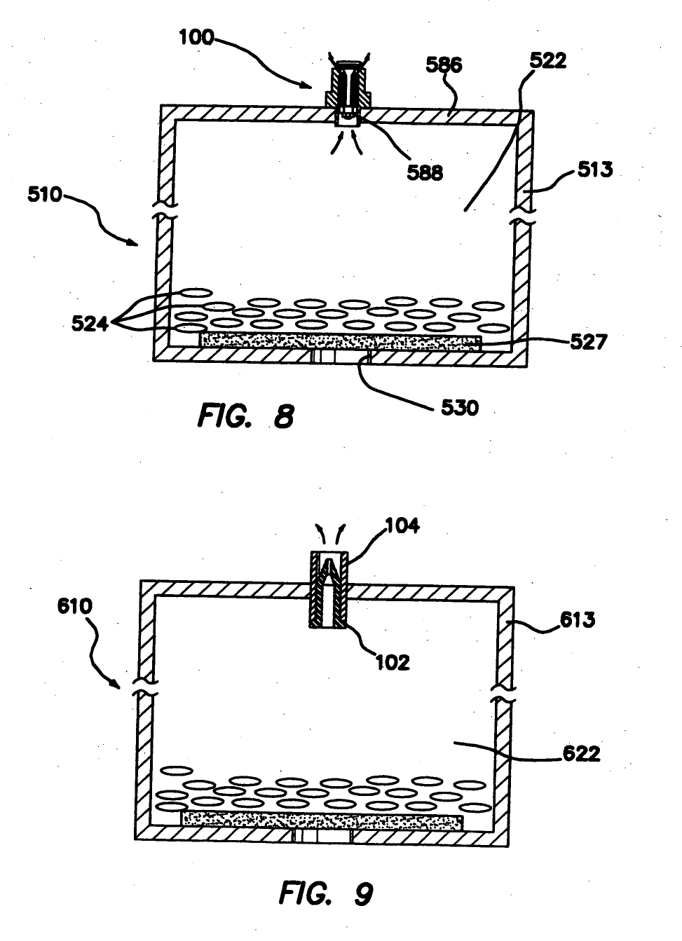

FIG. 8 shows a further valved controlled release system 510 of the present invention, that except as expressly described herein, is structured and functions substantially similarly to controlled release systems 10, 110, 210, 310 and 410. In particular, except as expressly described herein, valved system 510 is structured and functions similarly to valved system 410. The somewhat schematic character of FIG. 8 is meant to illustrate the distinguishing features of the further valved system 510.

The primary difference between further valved system 510 and valved system 410 is the inclusion of a spring valve, shown generally as 100, in further valved system 510, rather than the ball float valve 92 of valved system 410.

Spring valve 100 is situated largely external of casing body 513 and is in fluid communication with hollow interior 522 through second opening 588 in opposing second end wall 586. Spring valve 100 functions to be open to allow air to escape the hollow interior 522 of further valved system 510 and to be closed to prevent water and potability additive component from particles 524 to escape from hollow interior 522 through second opening 588.

### Example 24

FIG. 9 shows an additional valved controlled release system 610 of the present invention. Except as expressly described herein, additional valved system 610 functions similarly to controlled release systems 10, 110, 210, 310, 410 and 510. In particular, except as expressly described herein, valved controlled release system 610 is structured and functions similarly to valved system 410, with the primary difference being that ball float valve 92 in system 410 has been replaced by a one-piece high precision valve, specifically a duckbill valve 102. Duckbill valve 102 is sealed to a suitable valve housing 104 which is fitted, for example friction fitted, to casing body 614.

Duckbill valve 102 in this example is a one-piece, molded elastomeric duckbill valve that is open when there is a positive differential pressure in hollow interior 622 of casing body 613 relative to the exterior of the casing body 613. As water fills hollow interior 622, air passes freely through open duckbill valve 102. Once the hollow interior 622 is filled with water and the system 610 is fully immersed in water, pressure is equalized between hollow interior 622 and the exterior of casing body 613, causing duckbill valve to close to flow of material into or out of the hollow interior 622.

Duckbill valves suitable for use in the present systems are commercially available, for example, from Vernay Laboratories, Inc., having corporate headquarters located in Yellow Springs, Ohio.

### Example 25

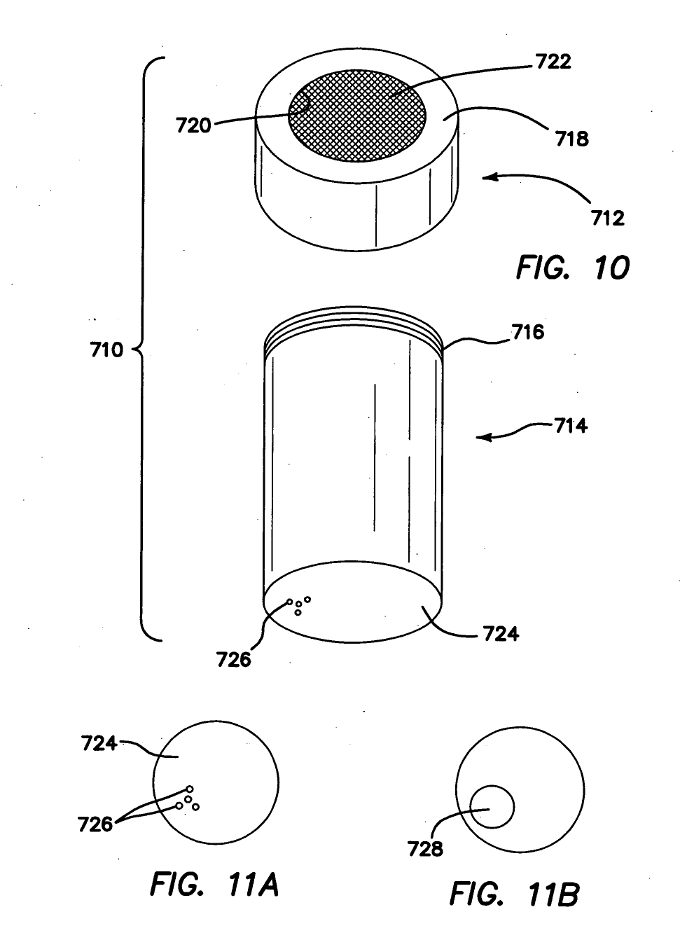

FIGS. 10, 11A and 11B show component parts of a still further potability additive composition container 710 in accordance with the present invention. Container 710 includes an end portion, such as a cap or lid, 712 and a casing body 714. The casing body 714 includes or defines an interior hollow space or hollow interior (defined by the inner walls of the casing body, which has a substantially open top) in which a potability additive composition is placed. Both the cap or lid 712 and the casing body 714 include complementary fastening structures to allow the cap and casing body to be coupled together and uncoupled from each other, as desired. The fastening structure (for example, outer or external threads) on casing body 714 is shown at 716. The lid 712 can be coupled to casing body 714 by rotation of one of the components relative to the other or by applying another coupling force to the components. In this manner, lid 712 can be removably coupled or affixed to casing body 714.

Both the lid 712 and the casing body 714 may comprise or be made of any suitable material, for example, one or more polymeric materials. Examples of useful polymeric materials include, without limitation, polyolefins, polyamides (nylon), any suitable polymeric material, such as those which are conventional and/or -well known and/or commercially available. Such polymeric materials may include polypropylene or polyethylene. The lid 712 and casing body may comprise the same polymeric material or different polymeric materials.

When the lid 712 comprises a polymeric material, this component is often made by a molding process, for example, using conventional and/or well known molding techniques. The casing body 714 may also be molded using conventional and well known techniques. The casing body and lid can be made using any suitable manufacturing process, for example, any conventional and/or well known process.

With particular reference to lid 712, the top portion or wall 718 is formed so as to have a through hole 720 in the top surface. A liquid permeable membrane member 722 is located so as to cover through opening 720.

In a particularly useful embodiment, membrane member 722 is molded into the lid 712, for example, co-molded with the lid 712. In this way, the membrane member 722 is fixedly attached to the cap 712 and completely covers the through hole 720.

The membrane member 722 may be made of any suitable material useful and effective in the application in which container 710 is to be used. Examples of useful materials from which the membrane member 722 can be produced include, without limitation, polyolefins, such as polypropylene, polyethylene, cellulose acetate, polyamides (nylon), polytetra-fluoroethylene (teflon) and the like. The membrane can be used in its native or untreated state or, if desired, can be further treated with one or more agents to impart one or more special or desired properties, for example, and without limitation a surface charge and the like, to the membrane to add in controlling release and/or to provide enhanced control of the release of the additive composition from the container.

The molding or co-molding process by which the membrane member 722 is molded in or co-molded with the lid 712 can be any conventional and/or well known molding or co-molding process. For example, the membrane member 722, in a form somewhat larger than the through hole 720, is placed in a mold with the center area of the membrane member being protected, so that the area that is protected is not covered by the polymeric material from which the lid 712 is made, and can be exposed in the final product or lid 712. A molten polymeric material is poured into the mold and the lid 712 is formed with the outer peripheral edge of the membrane member 722 covered by or molded in the polymeric material of the lid 712. Thus, for example, the outer edge of the membrane (not shown in FIG. 10), is located within the molded lid 712 and is secured to the polymeric material of the lid. Because the center portion of the membrane member 722 was protected during co-molding, the final lid 712 includes an exposed central membrane area, shown as membrane member 722 in FIG. 10.

The exposed area of membrane member 722 allows a liquid, for example, an aqueous liquid, to pass through through hole 720 and the membrane member, and come in contact with the potability additive composition within the hollow interior of the casing body 714. After contacting the additive composition, the liquid passes out of the container 710, for example, through through hole 720 and membrane member 722, at which point the liquid, for example, aqueous liquid or potable water, includes sufficient additive composition to have been treated with the potability additive composition as intended and/or desired.

As shown in FIG. 10, the area of the membrane member 722 that is exposed is relatively large. This allows for more contact between the liquid and the additive composition in the hollow interior space of container 710 and increased release of the potability additive composition into the liquid composition. The size of the exposed membrane member can be selected, as desired, to achieve the desired level of treatment/treatments of the liquid composition being treated.

The size of the casing body 714 (as well as the lid 712 and the exposed area of the membrane member 722) can be selected to satisfy the requirements of the application that is the potable water system, in which the container 710 is to be used. For example, the size of the casing body 714 can be such as to include a hollow interior space or hollow interior having any suitable volume, for example, and without limitation, a volume of about 1 ounce or less to about 100 ounces or more, such as of about 1 ounce to about 20 ounces or about 40 ounces or about 60 ounces or more.

Specific sizes of the hollow interior space of the casing body 714 include, but are not limited to, about 2 ounces, about 8 ounces, and about 16 ounces and about 32 ounces. Containers in accordance with the present invention may have any suitable size of hollow interior space, including sizes much larger than 32 ounces.

As shown in FIGS. 11A and 11B the bottom 724 of the casing body 714 includes a plurality of through holes 726. These through holes 726 can be produced in the process of molding the casing body 714 or by puncturing the bottom by mechanical and/or other force, (for example drilling or punching) for example, after the casing body 714 is molded or otherwise formed.

A valve, such as umbrella valve 728 shown in FIG. 11B, allows the majority of air to escape the hollow interior space of the container in use, and does not allow or prevents the liquid to be treated from passing across the valve either into or out of the hollow interior space. The valve may be selected with a desired back pressure to maintain a small amount or bubble of air in the container, for example, at the top of the container, when in use so that the only liquid to liquid contact is through the membrane, such as membrane member 722. In this way, the membrane can very effectively function in controlling the release of the potability additive composition from the container. The number, size, and arrangement of holes 726 are provided to specifically work with a specific valve, e.g., a specific umbrella valve. Different valves require different arrangements. For example, and without limitation a ball and seat valve requires only one, much larger opening or hole in which it sits.

One valve is generally adequate to allow air to be released from the hollow interior space if the container is oriented vertically or substantially vertically, that is with the valve and hole or holes being located above the membrane. However, if the orientation of the container is such that the hole or holes and membrane are horizontal or substantially horizontal to each other, two or more valves can be provided at two or more spaced apart locations so that one is always at the upper half of the container to allow sufficient air release and liquid entry to allow release of the potability additive composition from the container.

In one very useful embodiment, the container 712 shown in FIGS. 10, 11A and 11B can be used by placing a scale inhibitor or anti-scaling agent (component), such as polyacrylic acid, in the interior hollow space of the casing body 714. The container can then be used in a misting or mister system in which a stream of water is provided and is formed into a mist (fine liquid, e.g. water, droplets in air) for cooling or other purposes, for example, to be used to cool home air conditioners and increase their efficiency. In this particular application, the size of the interior hollow space of casing body 714 may be 2 (or about 2) ounces. This size of apparatus or container may be referred to as a “2 ounce bottle”.

Substantially the same apparatus can be provided in a 16 ounce (about 16 ounce) and 32 ounce (about 32 ounce) bottle, or interior hollow space size of the casing body 714, for use with large misting or mister systems, such as those systems used, for example, in amusement parks and sports venues. Such large bottles or containers may require a lid or cap which provides additional support for the exposed area of the membrane, since a large membrane surface may be, and often is, exposed in such relatively large containers. Such supported membrane members are discussed hereinafter.

The umbrella valve 728 employed may be the same regardless of the size of the container, for example, whether the size of the container 710 is 2 ounces or 32 ounces. A larger valve may be employed with a larger container (larger hollow interior space of casing body 714). Alternately, multiple valves, for example, two or more of the same valves, can be used with larger containers. Using the same valves regardless of container size advantageously reduces parts inventory and avoids manufacturing mistakes, for example, using the wrong valve.

In use, the container 710 may be placed in a flowing aqueous liquid, or a sump or other similar region, for example, where the aqueous liquid to be treated is present or collects, of a potable water system including the aqueous liquid to be treated. The container 710 is advantageously positioned so that the membrane member 722 is located below or at substantially the same level as the plurality of through openings 726. The preferred positioning is a vertical arrangement where the membrane member 726 is down and the air release valve 728 is at the top. Such positioning allows more effective removal of air from the hollow interior space of a casing body 714, and more effective contact of the aqueous liquid composition with the potability additive composition within the hollow interior space of the casing body.

### Example 26

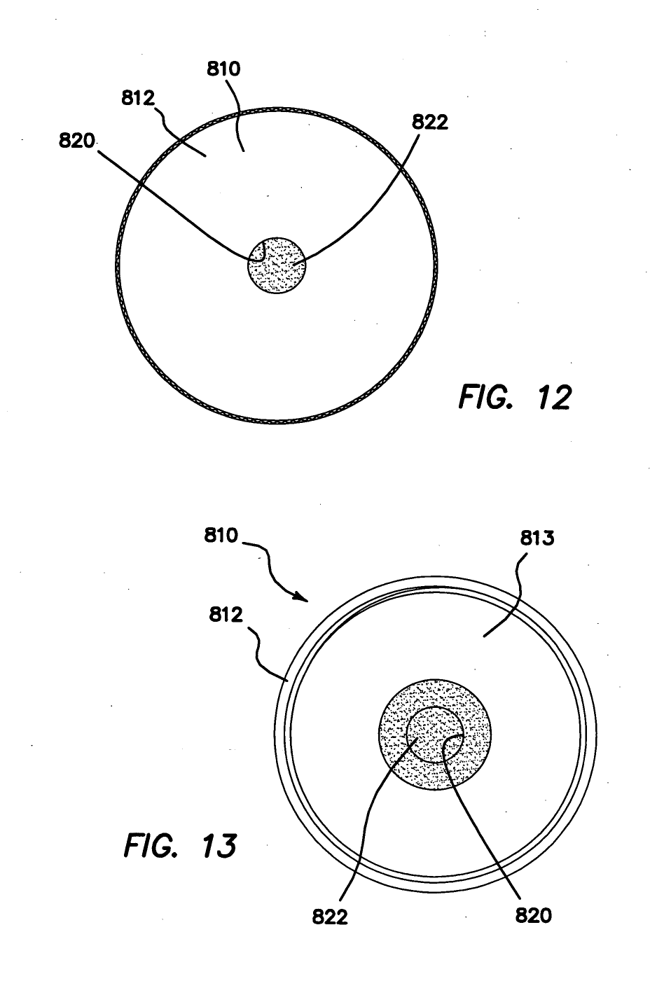

In FIG. 12, a lid 812 is shown and, except as expressly stated herein, is structured similarly to lid 712. The primary difference between lid 812 and lid 712 is the size of the opening 820. In particular, opening 820 is substantially smaller in size than opening 720. Thus, a smaller amount of membrane member 822 is exposed. This provides for less membrane area for the potability additive composition to diffuse through.

Without wishing to limit the invention to any particular theory of operation, it is believed that the mechanism by which the present containers work is diffusion, for example, analogous to diffusion through a cell wall in biological systems or diffusion through human skin. The amount of potability additive composition that passes through a given area in a given time frame depends, for example, on the difference in concentration across the membrane, such as a solution saturated or substantially saturated with additive composition inside the hollow interior space of the container and a lower, even substantially zero concentration of additive composition outside the container. The more exposed area there is, the larger the amount of additive composition can pass through the membrane.

A low solubility potability additive or additive composition requires a larger area to diffuse than a high solubility additive or potability additive composition. For example, a polyacrylate is highly soluble in water so the membrane area needed to release this additive into liquid water is relatively small. On the other hand, certain microbiocides may have limited solubility so that the membrane area needed to release such additives into liquid water is relatively large.

Container 810 may be employed and functions in a manner similar to that described with regard to container 710. Assuming that all other things are equal, for example, that containers 710 and 810 are the same size and hold the same potability additive composition and that membrane members 722 and 822 are the same in composition and structure, a lesser amount of potability additive composition per unit time is released from container 810 into an aqueous liquid relative to the rate of release of the potability additive composition with container 710. In one embodiment, the size of the exposed area of the membrane members might be enlarged or reduced to release a different potability additive composition at the same rate.

FIG. 13 shows the inner surface 813 of the lid 812 in which the membrane member 822 is co-molded to the cap 812. As shown, the membrane member 822 extends well outwardly of the exposed area of the membrane member 822, which exposed area is substantially defined by the opening 820 in the lid 812. Thus, the outer portion of the membrane member 822 is molded into the lid 812 and results in the membrane member 822 being firmly, and even fixedly, attached to the lid 812.

### Example 27

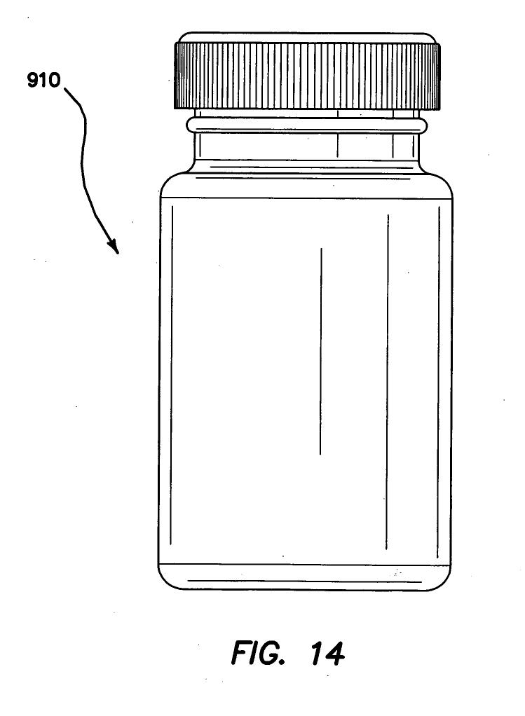

FIG. 14 shows an embodiment of an actual 2 ounce bottle 910 in accordance with the present invention.

### Example 28

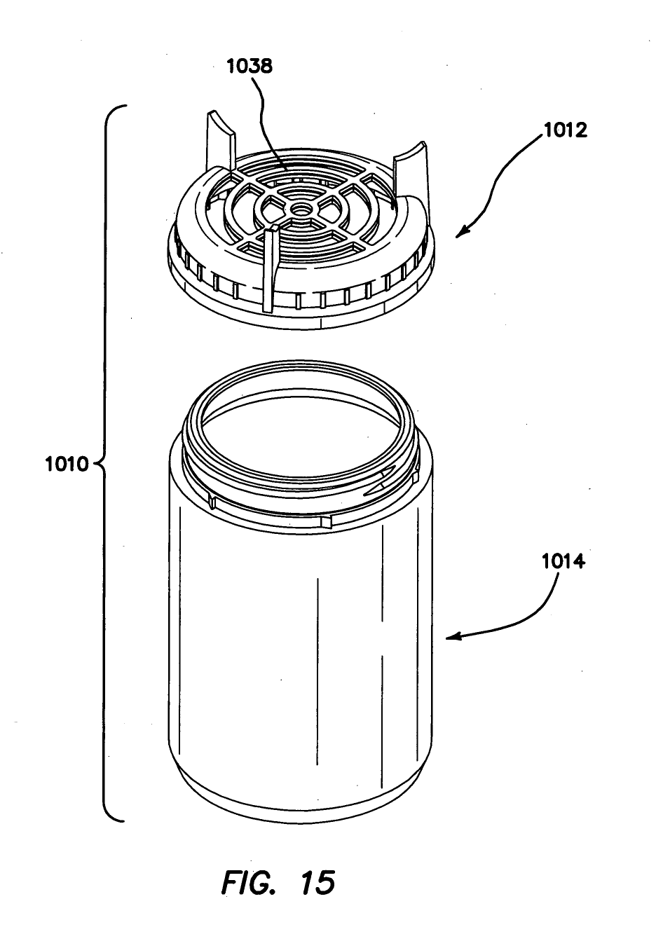

FIG. 15 shows a further alternate container 1010, somewhat similar to container 710, in accordance with the present invention. Container 1010 includes a support grid 1038 which is provided across the top of lid 1012. This support grid 1038, which can be molded into lid 1012, to form a unitary lid structure, extends across the exposed area of the membrane member 1022 (not shown in FIG. 15), which membrane member can be co-molded with the lid 1012 or otherwise secured to the lid 1012, to support the membrane member during use of container 1010. Alternatively, the peripheral portion of membrane member 1022 can be placed in a groove formed in lid 1012 and held in place by the pressure provided by the coupling of lid 1012 to casing body 1014. This type of container, with a support grid, is particularly useful when the exposed area of the membrane member is relatively large and the exposed area of the membrane member may be under stress and subject to being torn or otherwise punctured or damaged if not supported. The locking mechanism provided on lid 1012 and casing body 1014 is such as to allow the lid to be screwed on and secured to the casing body, but does not allow the lid to be removed from the casing body without effectively destroying the lid and/or the casing body, so that the container 1010 cannot be reused. Thus, container 1010 is a single use container and is disposed of after such single use.

In contrast, many of the other containers disclosed herein can be refilled with additive composition and reused. In certain cases, the lid and/or membrane are replaced before the container is reused.

### Example 29

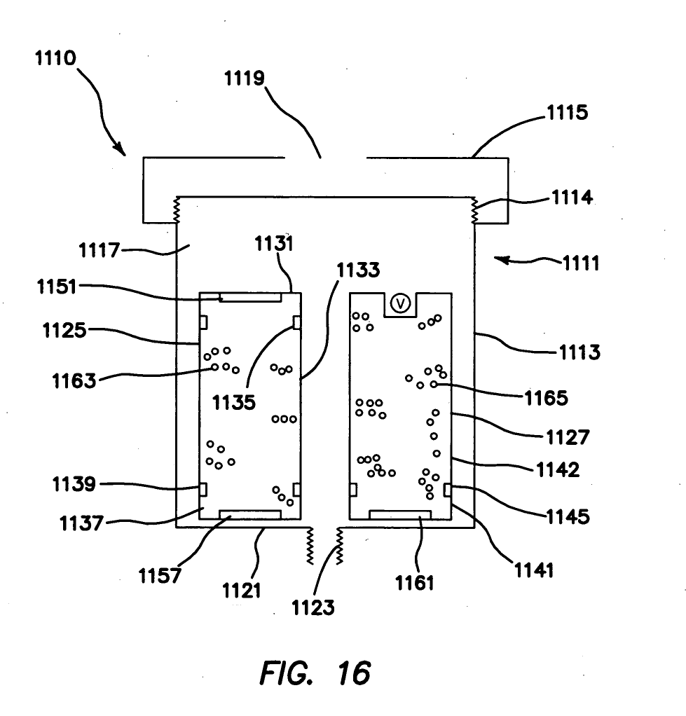

FIG. 16 shows a schematic view of a still further alternate container 1110 in accordance with the present invention.

Container 1110 includes an outer casing 1111 comprised of a body portion 1113 and a removable end portion 1115. End portion 1115 is removably secured to body portion 1113 by being rotated relative to body portion 1113 using mating threads, shown schematically at 1114, on both end portion 1115 and body portion 1113. Body portion 1113 defines an interior hollow space 1117. End portion 1115 includes an outlet 1119. The opposite end 1121 of body portion 1113 includes an inlet 1123.

Two inner casings 1125 and 1127 are located in hollow interior space 1117 of outer casing 1111. As shown in FIG. 16, the two inner casings 1125 and 1127 are situated in a side-by-side relationship. It should be noted that these inner casings 1125 and 1127 can be situated in a vertical stack, as opposed to the horizontal stack shown in FIG. 16, or can be randomly placed in the hollow interior space 1117. All of these embodiments are included within the scope of the present invention. It is advantageous to have at least a portion of the top of each inner casing 1125 and 1127 located above the bottom of the respective inner casing. This will allow for proper functioning of the inner casings 1125 and 1127 within the outer casing 1111.

Inner casing 1125 is structured and functions similarly to container 310 shown in FIG. 6. Also, inner casing 1127 is structured and functions similarly to container 410 shown in FIG. 7.

The primary difference between inner casing 1125 and container 310 is that inner casing 1125 includes a first end or top portion 1131 which is removably secured to the main or body portion 1133 of inner casing 1125 by rotatable mating threads, shown schematically at 1135. Also, a second or bottom portion 1137 of inner casing 1125 is removably secured to the main or body portion 1133 by rotatable mating threads, shown schematically in FIG. 16 at 1139.

In addition, the primary difference between inner casing 1127 and container 410 is that second or bottom portion 1141 is removably secured to the main or body portion 1143 of inner casing 1127 by rotatable mating threads, shown schematically at 1145.

These removable portions 1131, 1137 and 1141 allow the membranes 1151, 1157 and 1161, respectively, connected or secured to each of end portion to be replaced, for example, by replacing the entire end portion with a different end portion including a new membrane, after use of the container 1110.

The potability additive compositions 1163 and 1165 in the inner casings 1125 and 1127, respectively are different in chemical make-up from each other. However, the potability additive compositions in each of the inner casings 1125 and 1127 can have the same chemical make-ups.

In one embodiment, the potability additive compositions are different from each other because the additive compositions are or may be incompatible with each other so that if the two potability additive compositions were to be combined in a single casing or inner casing, the potability additive compositions could or would interact and/or otherwise degrade in activity to the disadvantage of the potable water system being treated. Also, one or both of the potability additive compositions in inner casings 1125 and 1127 may include a microbiocide which is dangerous for handling by humans. Placing such an additive component in an inner casing, for example, as the only active additive component in a clearly marked separate inner casing, included in an outer casing provides an additional safety feature by further isolating the dangerous material.

The container 1110 can be used as follows. With the inner casings 1125 and 1127 being filled with appropriate potability additive compositions, the container 1110 is provided to a potable water system for use. After a period of time in use, the potability additive compositions in the inner casings 1125 and 1127 are exhausted and the container 1110 is removed from service. The container 1110 is then returned to the manufacturer where the container is opened, by rotating the end portion 1115 relative to the body portion 1113 is checked to be sure the membranes and valve continue to be useful. For example, if one of the membranes has been compromised or is otherwise ineffective, the end portion of the inner casing in question can be removed and replaced by a new end portion with a new membrane. In any event, the inner casings are again filled with appropriate potability additive compositions and are ready to be provided to the application for use to provide for controlled release of the potability additive compositions.

If desired, the container 1110 can be sized so that more than two inner casings can be included in the interior hollow space 1117 of container 1110.

### Examples 30-41

Each of the potability additive component controlled release systems 10, 110, 210, 310, 410, 510, 610, 710, 810, 910, 1010 and 1110 of Examples 17-29 respectfully, is placed in a potable water system, in particular a drinking water system. The potability additive component in each of the systems is released in a controlled manner gradually with time into the potable water system to effectively benefit the water in the potable water system. Potability of the water in each of the potable water systems is achieved, maintained or otherwise enhanced as a result of using the controlled release system.

Certain aspects and advantages of the present invention may be more clearly understood and/or appreciated with reference to the following commonly owned United States patent applications, the disclosure of each of which is being incorporated herein in its entirety by this specific reference: U.S. patent application Ser. No. 12/154,900, filed May 27, 2008, entitled “Controlled Release Cooling Additive Composition”; and U.S. patent application Ser. No. 12/154,899, filed May 27, 2008, entitled “Controlled Release of Microbiocides”.

A number of publications, patents and patent applications have been cited hereinabove. Each of the cited publications, patents and patent applications are incorporated herein by reference in their entireties.

While this invention has been described with respect to various specific examples and embodiments, it is to be understood that the invention is not limited thereto and that it can be variously practiced with the scope of the following claims.

1. A potability additive composition for use in a potable water system, the composition comprising:
a potability additive component effective, when released into water in a potable water system, in enhancing the potability of the water; and
a controlled release component substantially surrounding the potability additive component, the controlled release component being effective, when the composition is placed in a potable water system, in controlling release of the potability additive component into water in the potable water system.

2. The potability additive composition of claim 1, wherein the controlled release component comprises a coating substantially surrounding the potability additive component.

3. The potability additive composition of claim 1, wherein the potability additive component includes a microbiocide component effective in the potable water system.

4. The potability additive composition of claim 1, wherein the controlled release component comprises at least one polymer.

5. (canceled)

6. The potability additive composition of claim 1, wherein the controlled release component is substantially insoluble in water in the potable water system.

7. (canceled)

8. (canceled)

9. (canceled)

10. The potability additive composition of claim 1, wherein the potable water system is a drinking water system.

11. The potability additive composition of claim 1 wherein the potability additive component comprises a precursor component effective, when released into water in a potable water system, to interact with a substance present in the water in the potable water system, thereby providing the water in the potable water system with an enhanced anti-microbial activity relative to the water in the potable water system without the release of the precursor component.

12. (canceled)

13. (canceled)

14. (canceled)

15. (canceled)

16. A method of releasing a potability additive component into water in a potable water system, the method comprising:
placing a potability additive composition in a position to be accessible to water in a potable water system, the additive composition comprising:
a potability additive component effective, when released into water in a potable water system, in enhancing the potability of the water; and
a controlled release component substantially surrounding the potability additive component, the controlled release additive component being effective, when the composition is placed in a potable water system, in controlling release of the additive component into water in the potable water system.

17. (canceled)

18. (canceled)

19. (canceled)

20. (canceled)

21. (canceled)

22. (canceled)

23. A controlled release system for releasing a potability additive component in a potable water system, the system comprising:
a water-impermeable casing defining a hollow interior, and at least one opening into the hollow interior;
a potability additive component located in the hollow interior of the casing; and
an element positioned in proximity to the at least one opening and effective in controlling the release of the potability additive component into water in the potable water system in contact with the casing.

24. The system of claim 23, wherein the element comprises a membrane.

25. (canceled)

26. The system of claim 24, wherein the membrane is water permeable.

27. (canceled)

28. (canceled)

29. (canceled)

30. The system of claim 23, wherein the potability additive component includes a microbiocide component effective in the potable water system.

31. (canceled)

32. The system of claim 30, wherein the microbiocide component is selected from the group consisting of halogen-containing microbiocides, halogen-releasing microbiocides, thiocarbamate microbiocides, thiocyano microbiocides, sulfate microbiocides, quaternary ammonium microbiocides, and mixtures thereof.

33. The system of claim 23, wherein the potability additive component comprises a precursor component effective, when released into water in a potable water system, to interact with a substance present in the water in the potable water system, thereby providing the water in the potable water system with an enhanced anti-microbial activity relative to the water in the potable water system without the release of the precursor component.

34. (canceled)

35. (canceled)

36. (canceled)

37. The system of claim 23, wherein the casing further includes a further opening into the hollow interior; and the container further comprises a structure operatively coupled to the further opening and operable to allow at least one of (a) air to pass out of the hollow interior through the further opening; and (b) water to pass into the hollow interior through the further opening.

38. (canceled)

39. The system of claim 37, wherein the structure comprises a valve operable between a first position to allow air to pass out of the hollow interior through the further opening and a second position to substantially prevent air from passing out of the hollow interior through the further opening.

40. The system of claim 37, wherein the structure comprises an air permeable membrane member structured and positioned to allow air to pass out of the hollow interior through the further opening and to substantially prevent water in the potable water system from passing out of the hollow interior through the further opening.

41. A method for releasing a potability additive component into water in a potable water system, the method comprising:
placing a controlled release system in a potable water system, the controlled release system comprising a water-impermeable casing defining a substantially hollow interior and at least one opening, a potability additive component in the hollow interior of the casing, and an element positioned in proximity to the at least one opening and effective to provide for controlled release of the potability additive component into the water in the potable water system.

42. The method of claim 41, which further comprises adding an amount of water to the interior of the casing effective to facilitate release of the potability additive component into the water in the potable water system.

43. The method of claim 41, wherein the element comprises a membrane.

44. (canceled)

45. (canceled)

46. (canceled)

47. (canceled)

48. (canceled)
